(19) United States
(12) Patent Application Publication
(10) Pub. No.: US 2013/0162742 A1
(43) Pub. Date: Jun. 27, 2013

(54) INKJET RECORDING APPARATUS

(71) Applicant: FUJIFILM CORPORATION, Tokyo (JP)

(72) Inventors: Takahiro INOUE, Kanagawa (JP); Koji FURUKAWA, Kanagawa (JP)

(73) Assignee: FUJIFILM CORPORATION, Tokyo (JP)

(21) Appl. No.: 13/724,822

(22) Filed: Dec. 21, 2012

(30) Foreign Application Priority Data
Dec. 27, 2011 (JP) 2011-285426
Oct. 17, 2012 (JP) 2012-229771

(51) Int. Cl. B41J 13/22

(52) U.S. Cl. CPC B41J 13/22
USPC 347/104

(57) ABSTRACT

An aspect of the present invention provides an inkjet recording apparatus, including: a conveyance device which has a moving suctioning surface and which conveys a cut sheet medium by suctioning the medium on the suctioning surface, a concavoconvex pattern being formed in the suctioning surface by arranging recess sections regularly in the suctioning surface, and suction holes each having an opening smaller than a size of openings of the recess sections being formed inside the recess sections; and a recording head which forms an image by ejecting ink by an inkjet method onto a surface of the medium which is conveyed by the conveyance device. According to the aspect, it is possible to prevent floating and wrinkling of the medium during conveyance, and an image of high quality can be recorded.

### BACKGROUND OF THE INVENTION

1. Field of the Invention

The present invention relates to an inkjet recording apparatus and more particularly, to an inkjet recording apparatus which suctions and conveys a medium.

2. Description of the Related Art

If printing is carried out using aqueous ink (an ink in which a coloring material, such as dye or pigment, is dissolved or dispersed in water or a water-soluble solvent) on general printing paper (paper of which main component is cellulose, such as coated paper which is used in general offset printing, rather than so-called special inkjet paper), then problems arise in that deformation (curl or cockling (undulation)) occurs in the paper after printing. Furthermore, even paper that has not been used takes in moisture when stored in a high-humidity environment and produces deformation in a similar manner.

In the case of double-side printing, and the like, paper which has deformed upon printing on the rear surface is used, but when deformed paper of this kind is used, wrinkles and floating up occur in the paper, and hence there is a problem in that an image of high quality cannot be printed. Furthermore, when printing by an inkjet method, there is also a problem in that the head rubs against the floating paper.

Japanese Patent Application Publication No. 2001-347710 and Japanese Patent Application Publication No. 2004-277028 disclose, as a device for resolving cockling, a method in which suction holes are formed in a paper conveyance surface, and the paper is conveyed while being suctioned.

Furthermore, Japanese Patent Application Publication No. 2004-277028 discloses a method of conveying paper by holding the paper by suction on a circumferential surface of a drum, in which an opening ratio of a suctioning surface becomes smaller from a central portion of the drum, in the width direction thereof, towards the end portions of the drum.

However, Japanese Patent Application Publication No. 2001-347710 and Japanese Patent Application Publication No. 2004-277028 employ a method in which paper is conveyed while being suctioned and slided over a conveyance surface, and hence involve a drawback in that, in the case of rear-side printing, the image on the surface that has already been printed is rubbed and the print quality is impaired.

Furthermore, in Japanese Patent Application Publication No. 2011-178547, since the opening ratio is varied in the width direction, then in the case of paper having a large amount of cockling right up to the end portions (for example, when printing on the rear surface of paper having images concentrated in both ends), the cockling in the end portions cannot be suppressed and there is a risk that floating will occur in end portions of the paper. Furthermore, since a differential is simply applied to the suctioning force in the width direction, then a structure which actively absorbs cockling of the paper is not achieved.

### SUMMARY OF THE INVENTION

The present invention has been devised in view of these circumstances, an object thereof being to provide an inkjet recording apparatus which can record images of high quality by preventing the occurrence of floating and wrinkling in a medium during conveyance.

Means for solving the problems are described below.

The first aspect of the present invention is an inkjet recording apparatus, including: a conveyance device which has a moving suctioning surface and which conveys a cut sheet medium by suctioning the medium on the suctioning surface, a concavoconvex pattern being formed in the suctioning surface by arranging recess sections regularly in the suctioning surface, and suction holes each having an opening smaller than a size of openings of the recess sections being formed inside the recess sections; and a recording head which forms an image by ejecting ink by an inkjet method onto a surface of the medium which is conveyed by the conveyance device.

In a case where cut sheet medium is conveyed by suctioning, wrinkling or floating of the medium occurs due to localized concentration of cockling because the cockling that occurs in the medium when it is sought to cause the medium to make tight contact with the suctioning surface has no place to escape. Therefore, in the present aspect, by forming a concavoconvex patter in the suctioning surface and forming (at least one) suction hole inside the recess sections, it becomes possible to absorb cockling of the medium when the medium is caused to make tight contact with the suctioning surface, in the recess sections. In this case, by forming a concavoconvex pattern by regularly arranging recess sections on the suctioning surface (for example, arranging recess sections uniformly in the front/rear and left/right in the conveyance direction of the medium), it is possible to absorb cockling efficiently over the whole area of the medium, and the whole surface of the medium can be caused to make tight contact with the suctioning surface. Furthermore, by arranging recess sections regularly on the suctioning surface, the medium can deform in a three-dimensional peak shape in the recess sections, and cockling can be absorbed efficiently regardless of the direction of the cockling which has occurred in the medium. More specifically, the direction in which cockling occurs varies depending on the machine direction of the paper (long grain or short grain), and is more liable to occur in the direction of the shorter dimension when the paper is in long grain and in the direction of the longer dimension when the paper is in short grain. However, by causing the paper to deform in a three-dimensional peak shape, it is possible efficiently to absorb cockling, even if the occurrence of cockling is biased in a particular direction. Furthermore, by setting the recess sections to have an opening shape with a closed periphery, it is possible to keep the interiors of the recess sections in a negative pressure state when a medium is suctioned, and it is possible to suction and hold the medium in a stable fashion. Moreover, by making the size of the suction holes smaller than the size of the openings of the recess sections, it is possible to set a low suction pressure while maintaining a high adhesive force. The recess sections in the first aspect are recess sections in which the opening has a particular shape, such as a rectangular (including a square) shape, or a rhomboid, circular or oval shape, or the like. Furthermore, the concavoconvex pattern is a concavoconvex pattern which is formed by regularly arranging the recess sections having the particular shape.

The second aspect of the present invention is the inkjet recording apparatus as defined in the first aspect, wherein the concavoconvex pattern is formed in the suctioning surface by arranging the recess sections in front/rear and left/right in a conveyance direction of the medium.

According to the second aspect of the invention, a concavoconvex pattern is formed in the suctioning surface by arranging recess sections in the front/rear and left/right in the conveyance direction of the medium. Consequently, it is possible to absorb cockling efficiently over the whole area of the medium and the whole surface of the medium can be caused to make tight contact with the suctioning surface. Furthermore, in the recess sections, it is possible to cause the medium to deform in a three-dimensional peak shape, and therefore cockling can be absorbed efficiently, regardless of the direction in which cockling occurs in the medium. In the second aspect, the recess sections are arranged with a fixed regularity. In this regard, there is no particular need for the interval (pitch) between adjacent recess sections to be uniform, provided that the recess sections are arranged according to a fixed repetition pattern. Therefore, it is possible for the arrangement interval in the front/rear direction and the arrangement interval in the left/right direction to be different, for example. By changing the arrangement interval between the recess sections in this way, it is possible to efficiently absorb cockling having a complex period fx (where, for example, fx=f1+f2+f3+ . . . fn). The pitch of the recess sections is synonymous with the interval between the recess sections. Additionally, meaning of the concavoconvex pattern in the second aspect is the same as in the first aspect.

The third aspect of the present invention is the inkjet recording apparatus as defined in the first or second aspect, wherein suction holes are also formed in projecting sections of the suctioning surface.

According to the third aspect of the invention, suction holes are formed in the projecting sections of the suctioning surface as well. Therefore, it is possible to effectively suppress floating of the medium which occurs on the projecting sections.

The fourth aspect of the present invention is the inkjet recording apparatus as defined in any one of the first to third aspects, wherein a grid-shaped concavoconvex pattern is formed in the suctioning surface by arranging rectangular recess sections uniformly in front/rear and left/right in a conveyance direction of the medium.

According to the fourth aspect of the invention, a grid-shaped concavoconvex pattern is formed in the suctioning surface by arranging rectangular recess sections uniformly in the front/rear and left/right in the conveyance direction of the medium. Furthermore, by forming the openings of the recess sections with a rectangular shape, it is possible to cause the medium to deform in a three-dimensional peak shape, and therefore cockling can be absorbed efficiently, regardless of the direction in which cockling occurs in the medium. Moreover, when the medium is suctioned, it is possible to keep the interior of the recess sections in a negative pressure state, and hence the medium can be suctioned and held in a stable fashion.

The fifth aspect of the present invention is the inkjet recording apparatus as defined in any one of the first to third aspects, wherein a checkerboard-shaped concavoconvex pattern is formed by arranging rectangular recess sections uniformly in front/rear and left/right in a conveyance direction of the medium.

According to the fifth aspect of the invention, a uniform checkerboard-shaped concavoconvex pattern is formed in the suctioning surface by arranging rectangular recess sections in the front/rear and left/right in the conveyance direction of the medium. Furthermore, by forming the openings of the recess sections with a rectangular shape, it is possible to cause the medium to deform in a three-dimensional peak shape, and therefore cockling can be absorbed efficiently, regardless of the direction in which cockling occurs in the medium. Moreover, when the medium is suctioned, it is possible to keep the interior of the recess sections in a negative pressure state, and hence the medium can be suctioned and held in a stable fashion.

The sixth aspect of the present invention is the inkjet recording apparatus as defined in the fourth of fifth aspect, wherein edges of the recess sections are inclined with respect to the conveyance direction of the medium.

According to the sixth aspect of the invention, edges of the recess sections which have openings formed in a rectangular shape are inclined with respect to the conveyance direction of the medium. Therefore, in the directions parallel to and perpendicular to the conveyance direction of the medium, there are no regions where only projecting sections are present, and cockling which occurs in the medium can be absorbed more efficiently in the recess sections.

The seventh aspect of the present invention is the inkjet recording apparatus as defined in the sixth aspect, wherein the edges of the recess sections are inclined at 45 degrees with respect to the conveyance direction of the medium.

According to the seventh aspect of the invention, the edges of the recess sections which have openings formed in a rectangular shape are inclined at 45 degrees with respect to the conveyance direction of the medium. Therefore, in the directions parallel to and perpendicular to the conveyance direction of the medium, there are no regions where only projecting sections are present, and cockling which occurs in the medium can be absorbed more efficiently in the recess sections. More specifically, it is possible to absorb cockling efficiently in the recess sections, whatever the direction in which cockling occurs.

The eighth aspect of the present invention is the inkjet recording apparatus as defined in any one of the fourth to seventh aspects, wherein a length of each of the edges of the recess sections exceeds 3 [mm] and is no greater than 10 [mm].

According to the eighth aspect of the invention, the length l of one edge of the recess sections which have openings formed with a rectangular shape is formed so as to exceed 3 [mm] and be no more than 10 [mm] (3 [mm]<1≦10 [mm]) If the length l of one edge of the recess sections is no more than 3 [mm] (1≦3 [mm]), then it is not possible to ensure an amount of distortion sufficient to be able to absorb cockling. On the other hand, if the length l of one edge exceeds 10 [mm] (if 10 [mm]≦1), then the twisting becomes too large. Consequently, by making the length l of one edge greater than 3 [mm] and no more than 10 [mm] (3 [mm]<1≦10 [mm]) it is possible to absorb cockling effectively. For example, desirably, the openings are rectangular openings of 5 [mm]×5 [mm].

The ninth aspect of the present invention is the inkjet recording apparatus as defined in the eighth aspect, wherein a width of each of the projecting sections (34) is no greater than 10 [mm].

According to the ninth aspect of the invention, the projecting sections are formed to have a width of no more than 10 [mm] This is because, if the width of the projecting sections exceeds the length of one edge of the recess sections, then the amount of cockling that is absorbed declines and it becomes impossible to absorb the cockling efficiently.

The tenth aspect of the present invention is the inkjet recording apparatus as defined in any one of the first to third aspects, wherein a honeycomb-shaped concavoconvex pattern is formed in the suctioning surface.

According to the tenth aspect of the invention, a honeycomb-shaped concavoconvex pattern is formed in the suctioning surface. If a honeycomb-shaped concavoconvex pattern is adopted, it is possible to absorb cockling efficiently in a similar fashion to when a grid-shaped or checkerboard-shaped concavoconvex pattern is adopted. By adopting a honeycomb-shaped pattern in particular, in the directions parallel to and perpendicular to the conveyance direction of the medium, there are no regions where only projecting sections are present, and cockling which occurs in the medium can be absorbed more efficiently in the recess sections.

The eleventh aspect of the present invention an inkjet recording apparatus, including: a conveyance device which has a moving suctioning surface and which conveys a cut sheet medium by suctioning the medium on the suctioning surface, a concavoconvex pattern being formed in the suctioning surface by arranging projecting sections regularly in the suctioning surface, and suction holes being arranged regularly in a region of the suctioning surface other than the projecting sections; and a recording head which forms an image by ejecting ink by an inkjet method onto a surface of the medium which is conveyed by the conveyance device.

According to the eleventh aspect of the invention, a concavoconvex pattern is formed in the suctioning surface by arranging projecting sections regularly on the suctioning surface. Consequently, it is possible to absorb cockling efficiently over the whole area of the medium and the whole surface of the medium can be caused to make tight contact with the suctioning surface. For instance, the projecting sections can be arranged in the front/rear and left/right in the conveyance direction of the medium. In this case, arranging the projecting sections means that the projecting sections are arranged with a fixed regularity. Consequently, there is no particular need for the interval between adjacent recess sections to be uniform, provided that the projecting sections are arranged according to a fixed repetition pattern. By changing the arrangement interval between the projecting sections in this way, it is possible to efficiently absorb cockling having a complex period fx (where, for example, fx=f1+f2+f3+ . . . fn). Additionally, the concavoconvex pattern is a concavoconvex pattern which is formed by regularly arranging the projecting sections having the particular shape.

The twelfth aspect of the present invention is the inkjet recording apparatus as defined in the eleventh aspect, wherein first straight lines which are parallel to a conveyance direction of the medium are arranged on the suctioning surface, second straight lines which are perpendicular to the conveyance direction of the medium are arranged on the suctioning surface, and the projecting sections are arranged at intersection points of the first straight lines and the second straight lines on the suctioning surface.

According to the twelfth aspect of the invention, a concavoconvex arrangement of a prescribed pattern is formed in the suctioning surface by arranging projecting sections at the intersection points between first straight lines that are parallel to the conveyance direction of the medium and second straight lines that are perpendicular to the conveyance direction of the medium. Consequently, it is possible to absorb cockling efficiently over the whole area of the medium and the whole surface of the medium can be caused to make tight contact with the suctioning surface. Additionally, there is no particular need for the interval (pitch) between the adjacent straight lines in the first/second straight lines to be uniform, provided that the straight lines are arranged according to a fixed regularity.

The thirteenth aspect of the present invention is the inkjet recording apparatus as defined in the twelfth aspect, wherein the suction holes are arranged in a center of each of regions demarcated by the first straight lines and the second straight lines.

According to the thirteenth aspect of the invention, suction holes are arranged in the centers of the regions demarcated by the first straight lines and the second straight lines. In other words, suction holes are arranged at equidistant positions from the adjacent projecting sections. Therefore, it is possible to absorb cockling efficiently in the recess sections, and the medium can be caused to make tight contact with the suctioning surface more effectively.

The fourteenth aspect of the present invention is the inkjet recording apparatus as defined in the eleventh aspect, wherein first straight lines which are inclined at an angle of λ with respect to a conveyance direction of the medium are arranged on the suctioning surface, second straight lines which are inclined at an angle of −λ, with respect to the conveyance direction of the medium are arranged on the suctioning surface, and the projecting sections are arranged at intersection points of the first straight lines and the second straight lines on the suctioning surface.

According to the fourteenth aspect of the invention, a concavoconvex pattern is formed in the suctioning surface by arranging projecting sections at the intersection points between first straight lines that are inclined by an angle λ with respect to the conveyance direction of the medium and second straight lines that are inclined by an angle −λ with respect to the conveyance direction of the medium. Consequently, it is possible to absorb cockling efficiently over the whole area of the medium and the whole surface of the medium can be caused to make tight contact with the suctioning surface. Additionally, meaning of the interval (pitch) between the adjacent straight lines in the first/second straight lines are the same as in the twelfth aspect.

The fifteenth aspect of the present invention is the inkjet recording apparatus as defined in the fourteenth aspect, wherein third straight lines which are perpendicular to the conveyance direction of the media and which pass through the intersection points are arranged on the suctioning surface, and the suction holes are arranged at a center of each of regions demarcated by the first straight lines, the second straight lines and the third straight lines.

According to the fifteenth aspect of the invention, suction holes are arranged in the centers of the regions demarcated by the first straight lines, the second straight lines and the third straight lines. In other words, suction holes are arranged at equidistant positions from the adjacent projecting sections. Therefore, it is possible to absorb cockling efficiently in the recess sections, and the medium can be caused to make tight contact with the suctioning surface more effectively. Additionally, there is no particular need for the interval (pitch) between the adjacent straight lines in the third straight lines to be uniform, provided that the straight lines are arranged according to a fixed regularity.

The sixteenth aspect of the present invention is the inkjet recording apparatus as defined in the eleventh or twelfth aspect, wherein suction holes are also formed in the projecting sections of the suctioning surface.

According to the sixteenth aspect of the invention, suction holes are formed in the projecting sections of the suctioning surface as well. Therefore, it is possible to effectively suppress floating of the medium which occurs on the projecting sections.

The seventeenth aspect of the present invention is the inkjet recording apparatus as defined in any one of the eleventh to thirteenth aspects, wherein the projecting sections are formed in a hemispherical shape.

According to the seventeenth aspect of the invention, projecting sections are formed in a hemispherical shape. Therefore, it is possible to absorb cockling efficiently in the recess sections, and the medium can be caused to make tight contact with the suctioning surface more effectively.

The eighteenth aspect of the present invention is the inkjet recording apparatus as defined in any one of the twelfth to seventeenth aspects, wherein the straight lines are arranged at a pitch of 2 to 9 [mm] and the projecting sections are formed to a height of no more than 0.3 [mm]

According to the eighteenth aspect of the invention, the straight lines are arranged at a pitch of 2 to 9 [mm] and the projecting sections are formed to a height of no more than 0.3 [mm].

The nineteenth aspect of the present invention is the inkjet recording apparatus as defined in any one of the first to eighteenth aspects, wherein a diameter of each of the suction holes is no more than 1 [mm].

According to this aspect of the invention, the suction holes are formed to a diameter of no more than 1 [mm] This is because if the diameter of the suction holes is large, then the suction flow rate increases, too much air is suctioned, and suction marks are left in the medium. By setting the diameter of the suction holes to no more than 1 [mm], it is possible to suction and hold the medium satisfactorily.

The twentieth aspect of the present invention is the inkjet recording apparatus as defined in any one of the first to nineteenth aspects, further comprising a nip device which nips the medium against the suctioning surface and causes a rear surface of the medium to make tight contact with the suctioning surface.

According to the twentieth aspect of the invention, a nip device is also provided to nip the medium against the suctioning surface and cause the rear surface of the medium to make tight contact with the suctioning surface. As described above, wrinkling and floating of the medium occurs due to localized concentration of cockling because the cockling that occurs in the medium when it is sought to cause the medium to make tight contact with the suctioning surface has no place to escape. However, by adopting a structure in which cockling can be absorbed in the recess sections as described above, it is possible to cause the medium to make tight contact with the suctioning surface without giving rise to wrinkling or floating, even if the media is forcibly caused to make tight contact with the suctioning surface by a nip device.

The twenty-first aspect of the present invention is the inkjet recording apparatus as defined in any one of the first to twentieth aspects, further comprising a back tension application device which applies back tension to the medium transferred to the conveyance device, by suctioning a front surface or a rear surface of the medium transferred to the conveyance device.

According to the twenty-first aspect of the invention, a back tension application device is also provided to apply a back tension to a medium which is transferred to the conveyance device. Consequently, when the media is suctioned against the suctioning surface, it is possible to suction the medium in a stretched (tautly pulled) state, and therefore the occurrence of wrinkling and floating can be prevented more effectively.

According to the above aspects of the present invention, it is possible to prevent floating and wrinkling of the medium during conveyance, and an image of high quality can be recorded. In particular, when carrying out rear surface printing in double-side printing, it is possible to effectively suppress the occurrence of floating and wrinkling.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of a main part of one embodiment of an inkjet recording apparatus relating to the present invention;

FIG. 2 is an expanded diagram showing a composition of the circumferential surface (suctioning surface) of a conveyance drum;

FIG. 3 is an enlarged diagram showing an enlarged view of a portion of FIG. 2;

FIG. 4 is a perspective diagram of FIG. 3;

FIG. 5 is a cross-sectional view along 5-5 in FIG. 3;

FIG. 6 is a schematic drawing showing a state of paper when suctioned;

FIG. 7 is an enlarged diagram of a circumferential surface (suctioning surface) of a conveyance drum in which suction holes are formed in the projecting sections as well;

FIGS. 8A and 8B are cross-sectional diagrams along 8A-8A and 8B-8B in FIG. 7;

FIG. 9 is an enlarged diagram showing a further mode of a concavoconvex pattern on a circumferential surface (suctioning surface) of a conveyance drum;

FIG. 10 is an enlarged diagram showing a further mode of a concavoconvex pattern on a circumferential surface (suctioning surface) of a conveyance drum;

FIG. 11 is an enlarged diagram showing a further mode of a concavoconvex pattern on a circumferential surface (suctioning surface) of a conveyance drum;

FIG. 12 is an enlarged diagram showing a further mode of a concavoconvex pattern on a circumferential surface (suctioning surface) of a conveyance drum;

FIG. 13 is an expanded diagram showing a composition of a further embodiment (1) of a circumferential surface (suctioning surface) of a conveyance drum;

FIG. 14 is an enlarged diagram showing an enlarged view of a portion of FIG. 13;

FIG. 15 is an expanded diagram showing a composition of a further embodiment (2) of a circumferential surface (suctioning surface) of a conveyance drum;

FIG. 16 is an enlarged diagram showing an enlarged view of a portion of FIG. 15;

FIG. 17 is a perspective diagram of FIG. 16;

FIG. 18 is an enlarged diagram of a circumferential surface (suctioning surface) of a conveyance drum in which suction holes are formed in the projecting sections as well;

FIG. 19 is an enlarged diagram showing a composition of a further embodiment (2) of a circumferential surface (suctioning surface) of a conveyance drum;

FIG. 20 is an enlarged diagram showing a composition of yet a further embodiment of a circumferential surface (suctioning surface) of a conveyance drum;

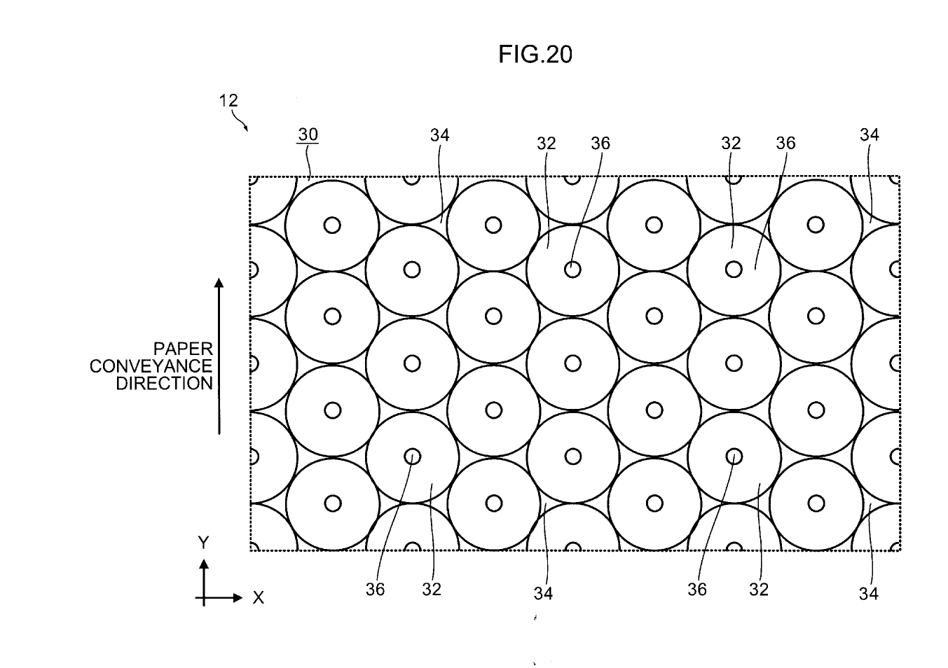

FIG. 21 is an enlarged diagram showing a composition of yet a further embodiment of a circumferential surface (suctioning surface) of a conveyance drum;

FIG. 22 is an expanded diagram showing a composition of a circumferential surface of a conveyance drum (suctioning surface) in which a concavoconvex arrangement is formed by arranging projecting sections on the circumferential surface;

FIG. 23 is an enlarged diagram showing an enlarged view of a portion of FIG. 22;

FIG. 24 is a cross-sectional view along 24-24 in FIG. 23;

FIG. 25 is an enlarged diagram showing a further mode of a concavoconvex pattern on a circumferential surface (suctioning surface) of a conveyance drum;

FIG. 26 is an enlarged diagram showing a further mode of a concavoconvex pattern on a circumferential surface (suctioning surface) of a conveyance drum;

FIG. 27 is an enlarged diagram showing a further mode of a concavoconvex pattern on a circumferential surface (suctioning surface) of a conveyance drum;

FIG. 28 is an enlarged cross-sectional diagram showing a further mode of a circumferential surface (suctioning surface) of a conveyance drum;

FIG. 29 is an enlarged cross-sectional diagram showing a further mode of a circumferential surface (suctioning surface) of a conveyance drum;

FIG. 30 is an enlarged cross-sectional diagram showing a further mode of a circumferential surface (suctioning surface) of a conveyance drum;

FIG. 31 is an enlarged diagram showing a further mode of a concavoconvex pattern on a circumferential surface (suctioning surface) of a conveyance drum;

FIG. 32 is a general schematic drawing of a main part of a further embodiment of an inkjet recording apparatus relating to the present invention;

FIG. 33 is a general schematic drawing showing one example of an inkjet recording apparatus which incorporates a back tension application apparatus;

FIG. 34 is a perspective diagram showing a schematic view of the composition of a back tension application apparatus;

FIG. 35 is a lower surface diagram of the suction unit (a plan diagram of the suction holding surface);

FIG. 36 is a general schematic drawing of a case where a back tension application apparatus is incorporated into an inkjet recording apparatus which conveys paper on a belt;

FIG. 37 is a general schematic drawing of a back tension application apparatus which applies a back tension by suctioning a rear surface of paper;

FIG. 38 is a table showing experimental results of investigation into the circumstances under which floating of paper occurred when an interval between projecting sections was varied; and

FIG. 39 is a table showing experimental results of investigation into the circumstances under which image non-uniformities occurred when a height of projecting sections was varied.

### DESCRIPTION OF THE PREFERRED EMBODIMENTS

### Composition of Inkjet Recording Apparatus (Main Part)

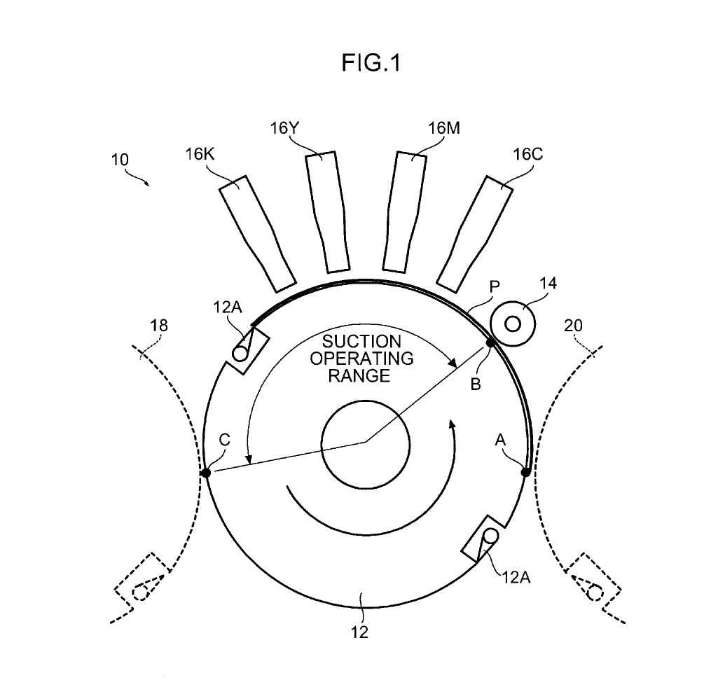

FIG. 1 is a general schematic drawing of a main part of one embodiment of an inkjet recording apparatus relating to the present invention.

This inkjet recording apparatus 10 is an inkjet recording apparatus which records color images on a printing surface of paper P by ejecting inks of four colors, cyan (C), magenta (M), yellow (Y) and black (K), onto paper (for example, general printing paper) P which is a cut-sheet medium. The inkjet recording apparatus 10 includes a conveyance drum 12 which conveys paper P by holding the paper P by suction on a circumferential surface, a pressing roller 14 which nips the paper P against the conveyance drum 12 and causes the paper P to make tight contact with the circumferential surface of the conveyance drum 12, and inkjet heads 16C, 16M, 16Y and 16K which form a color image on a surface of paper P conveyed by the conveyance drum 12 by ejecting ink droplets of respective colors of C, M, Y and K onto the surface of the paper P.

Paper P is wrapped about a circumferential surface of the conveyance drum 12, held by suction thereon, and the drum 12 is rotated, thereby conveying the paper P.

A motor (not illustrated) is coupled to the conveyance drum 12. The conveyance drum 12 is driven by the motor to rotate. Due to the rotation of the conveyance drum 12, the outer circumferential surface which is the suctioning surface of the paper P is rotated.

Grippers 12A are provided on the conveyance drum 12 (in the present example, grippers 12A are provided at two locations on the outer circumferential surface of the drum). The paper P is conveyed with the leading end portion thereof being gripped by a gripper 12A.

A plurality of suction holes are formed in the circumferential surface (suctioning surface) of the conveyance drum 12. The paper P is suctioned and held on the circumferential surface (suctioning surface) of the conveyance drums 12, due to the rear surface of the paper being suctioned from the suction holes. This point is described in detail below.

The range of operation of the suctioning function of the conveyance drum 12 (suctioning operation range) is limited to a prescribed angular range, in such a manner that the suctioning function operates from the installation position of the pressing roller 14 (pressing position) B to the transfer position C of the paper P onto a conveyance device 18 of the subsequent stage (in the present embodiment, a conveyance drum).

The pressing roller 14 functions as a nip device which nips the paper P against the conveyance drum 12 and causes the paper P to make tight contact with the circumferential surface of the conveyance drum 12. The pressing roller 14 is arranged between the transfer position A of the paper P from a conveyance device of the previous stage (in the present embodiment, a conveyance drum) 20, and the inkjet head 16C which is positioned on the furthest upstream side. This pressing roller 14 is composed by a rubber roller (a roller of which at least an outer circumferential portion is made of rubber (an elastic body)), and is arranged in parallel with the conveyance drum 12, as well as being pressed against the circumferential surface of the conveyance drum 12.

The paper P of which leading end is held by the gripper 12A is nipped between the pressing roller 14 and the conveyance drum 12 upon passing the installation position of the pressing roller 14, and hence makes tight contact with the circumferential surface of the conveyance drum 12.

As described above, in the conveyance drum 12, a suctioning force acts from the installation position of the pressing roller 14, and therefore the paper P is suctioned on the circumferential surface of the conveyance drum 12 while being pressed by the pressing roller 14.

The inkjet heads 16C, 16M, 16Y and 16K are composed by so-called line heads, and are formed to a length corresponding to the width of the paper P (the length of the paper in a direction perpendicular to the conveyance direction).

The inkjet heads 16C, 16M, 16Y and 16K are installed in a head installation section, which is not illustrated, and are arranged at prescribed positions. More specifically, the inkjet heads are arranged at a uniform pitch (interval) apart along the conveyance path of the paper P by the conveyance drum 12, and are arranged in such a manner that nozzle rows formed on nozzle surfaces thereof are perpendicular to the conveyance direction of the paper P. Furthermore, the nozzle surfaces are arranged so as to face the outer circumferential surface of the conveyance drum 12 and the nozzle surfaces are arranged so as to be disposed at a prescribed height from the outer circumferential surface of the conveyance drum 12.

Thereupon, when the paper P conveyed by the conveyance drum 12 passes below the inkjet heads 16C, 16M, 16Y and 16K, ink droplets of the respective colors of C, M, Y and K are ejected from the inkjet heads 16C, 16M, 16Y and 16K, and an image is thereby formed (recorded) on the printing surface.

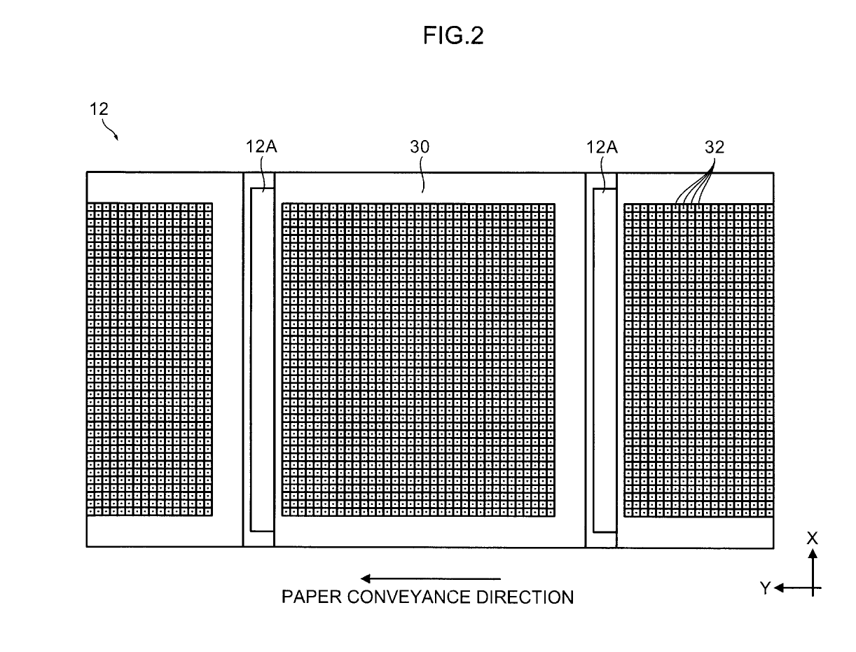

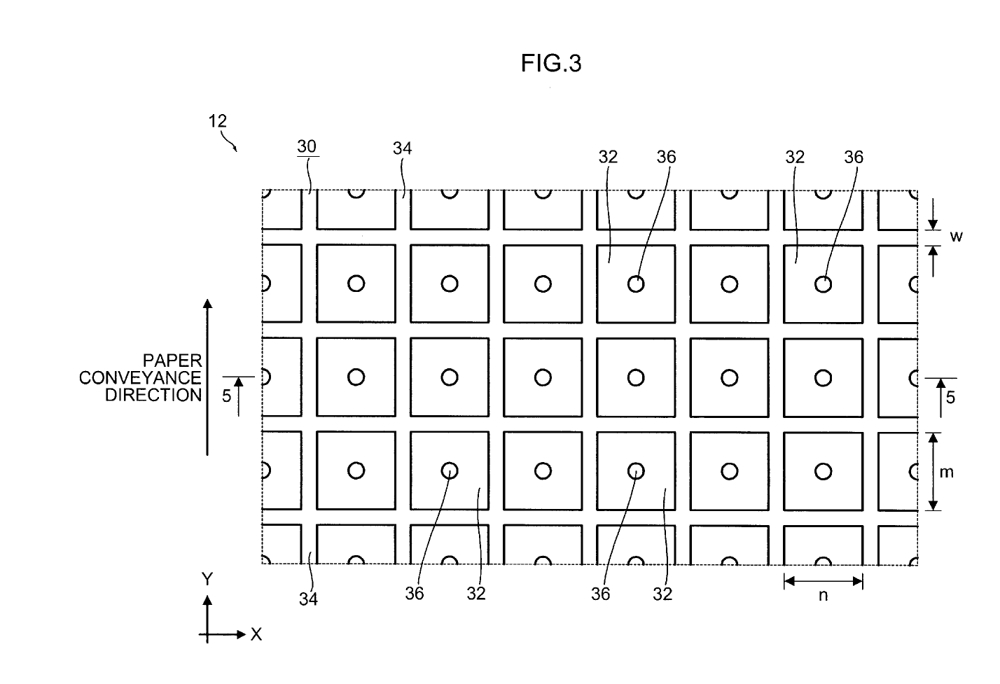

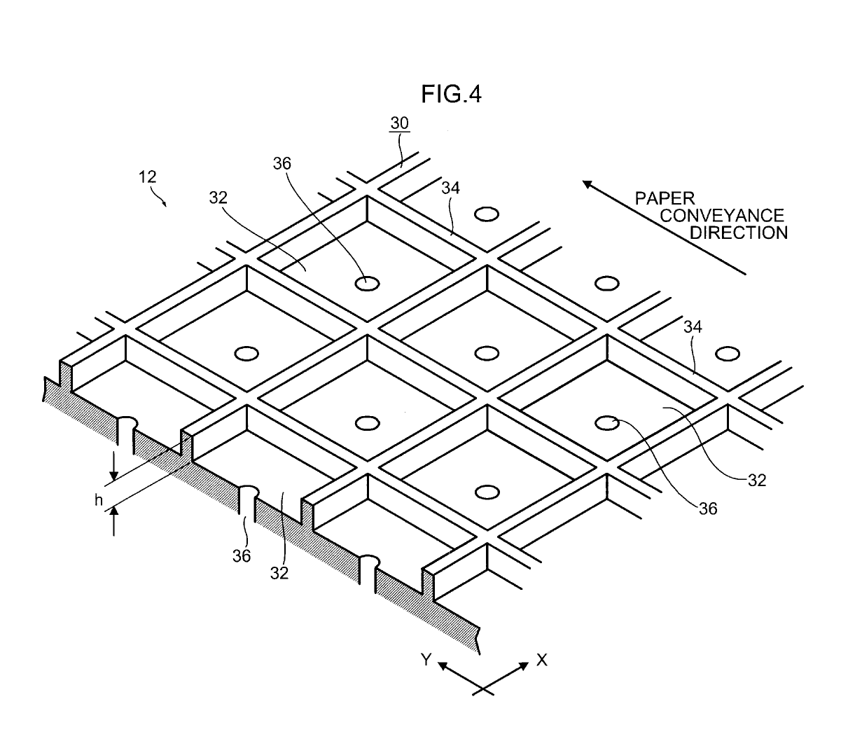

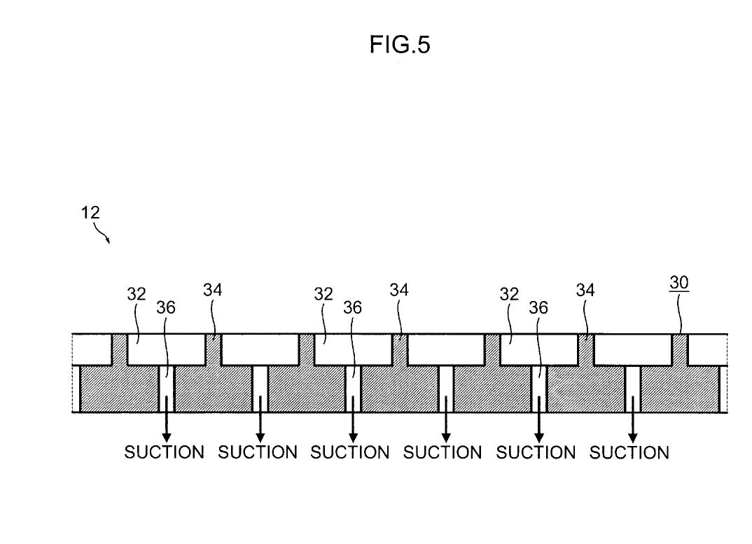

FIG. 2 is an expanded diagram showing a composition of the circumferential surface (suctioning surface) of the conveyance drum, and FIG. 3 is an enlarged diagram showing an enlarged view of a portion of FIG. 2. Furthermore, FIG. 4 is a perspective view of FIG. 3, and FIG. 5 is a cross-sectional view along 5-5 in FIG. 3.

As shown in FIGS. 2 to 5, an concavoconvex surface is formed in the circumferential surface (suctioning surface) 30 of the conveyance drum 12, by uniformly arranging, at fixed pitch, recess sections 32 having a rectangular opening shape, in the front/rear direction and left/right direction with respect to the conveyance direction of the paper P (the front/rear direction being a direction (Y) perpendicular to the conveyance direction and the left/right direction being a direction parallel to the conveyance direction (X)), in the holding region of the paper P (the region which is conveyed by the paper P during conveyance).

In the example shown in FIGS. 2 to 5, recess sections 32 having a rectangular shape with four edges of equal length (a square shape) are arranged in series at a fixed pitch following the conveyance direction of the paper P, and are also arranged in series at a fixed pitch following the direction perpendicular to the conveyance direction of the paper P (namely, the axial direction of the conveyance drum 12), thereby forming a grid-shaped concavoconvex arrangement. By this means, rib-shaped projecting sections 34 are formed in a grid shape and a grid-shaped concavoconvex arrangement is formed on the circumferential surface (suctioning surface) 30.

Suction holes 36 for suctioning the paper P are formed by openings in a center of a bottom surface of each recess section 32. These suction holes 36 are formed to be smaller than the openings of the recess sections 32. The suction holes 36 are connected to a suction chamber (not illustrated) which is provided inside the conveyance drum 12, in the suction operating range. The suction chamber is connected to a suctioning apparatus, such as a vacuum pump (not illustrated), and air inside the suction chamber is sucked out by this suctioning apparatus.

The action of the conveyance drum 12 which is composed as described above is as follows.

As described above, paper P is wrapped about a circumferential surface 30 of the conveyance drum 12, the rear surface of the paper P is held by suction thereon, and the conveyance drum 12 is rotated, thereby conveying the paper P.

The rear surface of the paper P which is wrapped about the circumferential surface 30 of the conveyance drum 12 is supported by the projecting sections 34 of the circumferential surface 30 which is formed as a concavoconvex surface. The rear surface of the paper is suctioned by the recess sections 32 and thereby suctioned and held on the circumferential surface 30.

By holding the paper P by suction on the circumferential surface (suctioning surface) 30 in which a concavoconvex arrangement is formed in this way, during rear surface printing in double-side printing, and the like, it is possible effectively to suppress the occurrence of floating and wrinkling. In general, floating and wrinkling arise when deformation (cockling, etc.) which occurs in paper as it is sought to cause the paper to make tight contact with the suctioning surface has no place to escape and becomes concentrated locally. By forming a circumferential surface (suctioning surface) 30 in a concavoconvex shape, as in the conveyance drum 12 according to the present embodiment, it is possible for deformation occurring in the paper P to escape in the recess sections 32, and hence the occurrence of floating or wrinkling can be suppressed effectively.

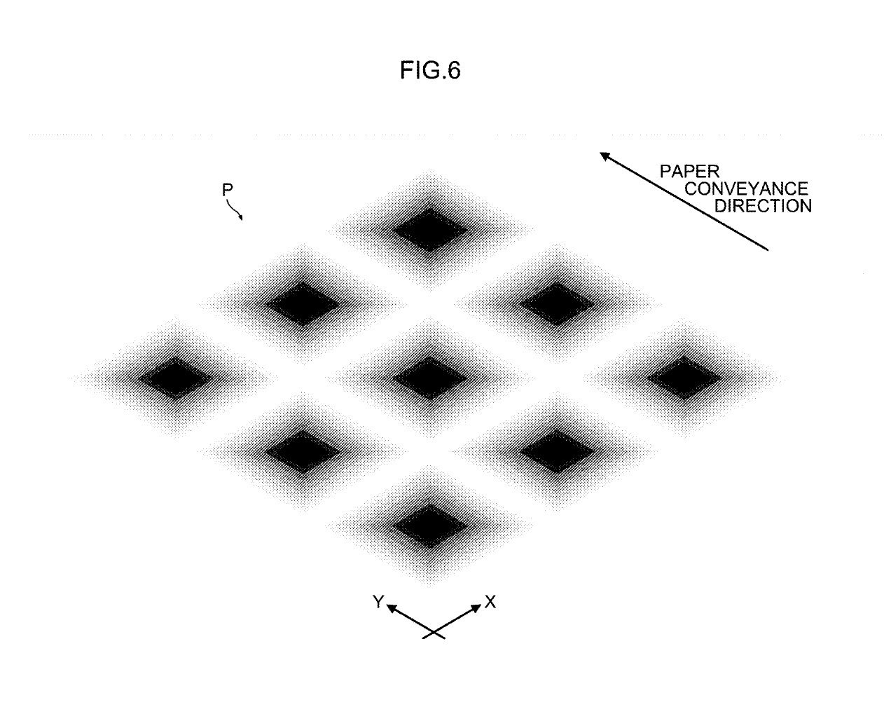

In particular, by forming a concavoconvex surface by uniformly arranging rectangular recess sections 32, when the paper P is suctioned, it is possible to cause the paper P to deform in a three-dimensional peak shape in each recess section 32, as shown in FIG. 6, and deformation (cockling, etc.) in each direction can be suctioned effectively. More specifically, the direction in which cockling occurs varies depending on the machine direction of the paper (long grain and short grain), and is more liable to occur in the direction of the shorter dimension when the paper is in long grain and to occur in the direction of the longer dimension when the paper is in short grain. However, by causing the paper P to deform in a three-dimensional peak shape, it is possible efficiently to absorb deformation in any direction. Consequently, it is possible to prevent the occurrence of floating and wrinkling effectively.

Furthermore, by forming the concavoconvex arrangement uniformly through the whole of the region where the paper P is held, it is possible to suction and hold the whole area of the paper P, without giving rise to wrinkling or floating.

Furthermore, by adopting a composition having a grid-shaped concavoconvex arrangement and closing off the outer circumferences of the recess sections 32 (surrounding the four perimeter surfaces of each recess section 32 with projecting sections 34), it is possible to keep the interior of the recess sections 32 in a negative pressure state when the paper P is suctioned. Consequently, it is possible to cause the rear surface of the paper P to make tight contact with the suctioning surface, and the paper P can be suctioned and held in a reliable fashion.

Moreover, by making the size (cross-sectional area) of the suction holes 36 formed in the recess sections 32 smaller than the size (surface area) of the openings of the recess sections 32, it is possible to set a low suction pressure while raising the adhesive force. Consequently, it is possible to prevent the occurrence of suction marks (marks caused by the projecting sections 34 formed in a rib shape), and the like, in the paper P.

The depth of the recess sections 32 formed in the circumferential surface (the height of the projecting sections 34 formed in a rib shape) h is desirably set in a range of 0 mm<h≦0.5 mm, and more desirably set to 0.5 (mm). This is because the amount of distortion of the paper P in one recess section 32 is limited by the depth of the recess section 32 (the height of the projecting sections 34 formed in a rib shape), in such a manner that the absorption of cockling is not concentrated in one location. Moreover, if the depth of the recess sections 32 (the height of the projecting sections 34 formed in a rib shape) h is made greater than 0.5 [mm], then the amount of distortion absorbed in the recess sections 32 becomes large, and suction marks (the marks of the projecting sections 34 formed in a rib shape) become more liable to occur in the paper P.

In the recess sections 32 which are formed in a rectangular shape, if the length of the edges parallel to the conveyance direction of the paper (front/rear direction) is represented by m and the length of the edges in a direction perpendicular to the conveyance direction of the paper P (left/right direction) is represented by n (m×n), then m and n are desirably set in a range of 3 [mm]<m≦10 [mm], 3 [mm]<n≦10 [mm], and are more desirably set to m=n=5 [mm] This is because, if the length of one edge is no more than 3 [mm], then it is not possible to ensure an amount of distortion capable of absorbing cockling.

If the opening shape of the recess sections 32 is an oblong shape, then the long edges may be either the edges parallel to the conveyance direction of the paper (front/rear direction) or the edges in a direction perpendicular to the conveyance direction of the paper P (left/right direction).

In this case, if the basis weight of the paper P is 58 to 157 [gsm] (Young's modulus E: 2 to 15 [GPa]), then it is desirable to set the suctioning pressure to 1 [kPa] to 30 [kPa] in order to achieve an amount of distortion that is no more than the depth h of the recess sections 32.

An equation indicating this relationship is given below.

σ=0.709×(PL4/Et3) [Expression 1]

This equation is the amount of distortion σ[mm] when the perimeter of the paper P is supported, and represents the amount of distortion σ[mm] when the thickness of the paper P is t [mm], the supporting width is 2 L [mm] and the distributed load is P [Pa].

If the amount of distortion σ is 0.5 [mm] and the lengths m×n of the edges of the recess sections 32 are 5 [mm]×5 [mm], and the length of the paper before deformation is 530 [mm], then an amount of elongation of approximately 9 [mm] at maximum can be absorbed.

The width w of the projecting sections 34 formed in a rib shape is desirably set in a range of 0 [mm]<w≦10 [mm], and more desirably, w m, n, in order to support the paper P. This is because the amount of absorbed cockling is reduced if the width w of the projecting sections 34 formed in a rib shape is longer than the lengths m, n of the respective edges of the recess sections 32.

The diameter d of the suction holes 36 is desirably set in a range of 0 [mm]<d≦1 [mm] This reason for this is that, if the diameter d of the suction holes 36 is greater than 1 [mm], then the suctioning flow rate is increased and the paper is suctioned excessively, and hence there is a risk of leaving suction marks in the paper P.

Furthermore, it is also possible to provide two or more suction holes 36 in each recess section 32, but desirably, there is one suction hole 36 in each recess section 32. This is because, if two or more suction holes 36 are provided in each recess section 32, similarly to when the diameter is increased, the suction flow rate increases, and there is a risk of leaving suction marks in the paper P due to excessive suctioning.

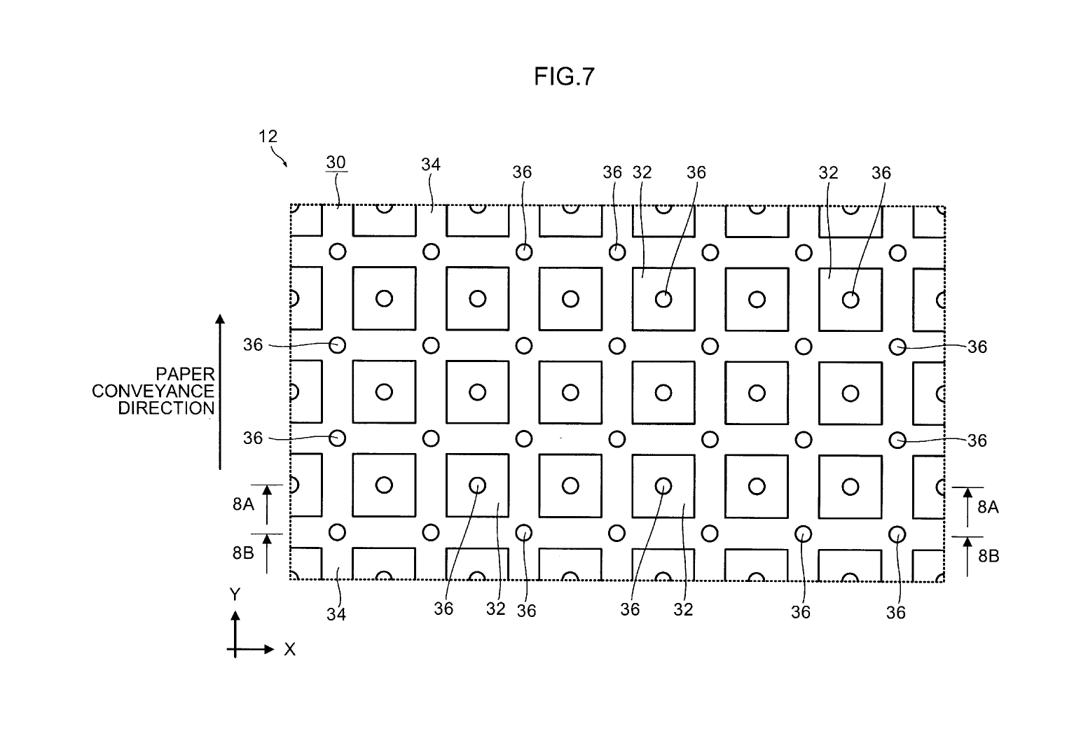

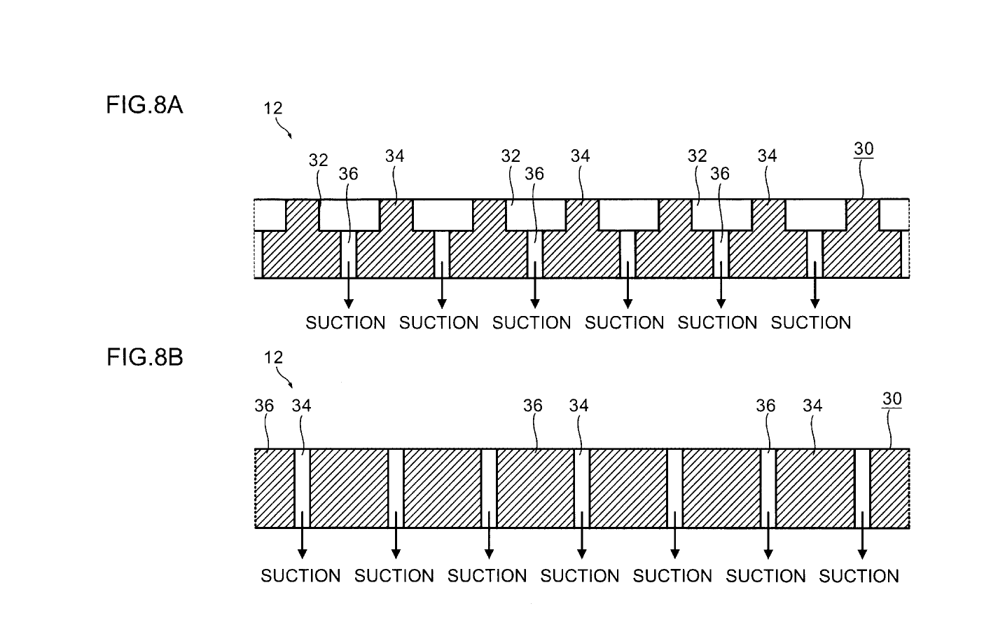

In the embodiment described above, suction holes are formed in the recess sections only, but it is also possible to form suction holes in the projecting sections which are formed in a rib shape, as well. FIG. 7 is an enlarged diagram of a circumferential surface (suctioning surface) of a conveyance drum in which suction holes are formed in the projecting sections as well. Furthermore, FIGS. 8A and 8B are respectively a cross-sectional diagram along 8A-8A in FIG. 7 and a cross-sectional diagram along 8B-8B in FIG. 7. By forming suction holes 36 in the surface of the projecting sections 34 in this way, it is possible to prevent floating up of the paper P on the projecting sections 34.

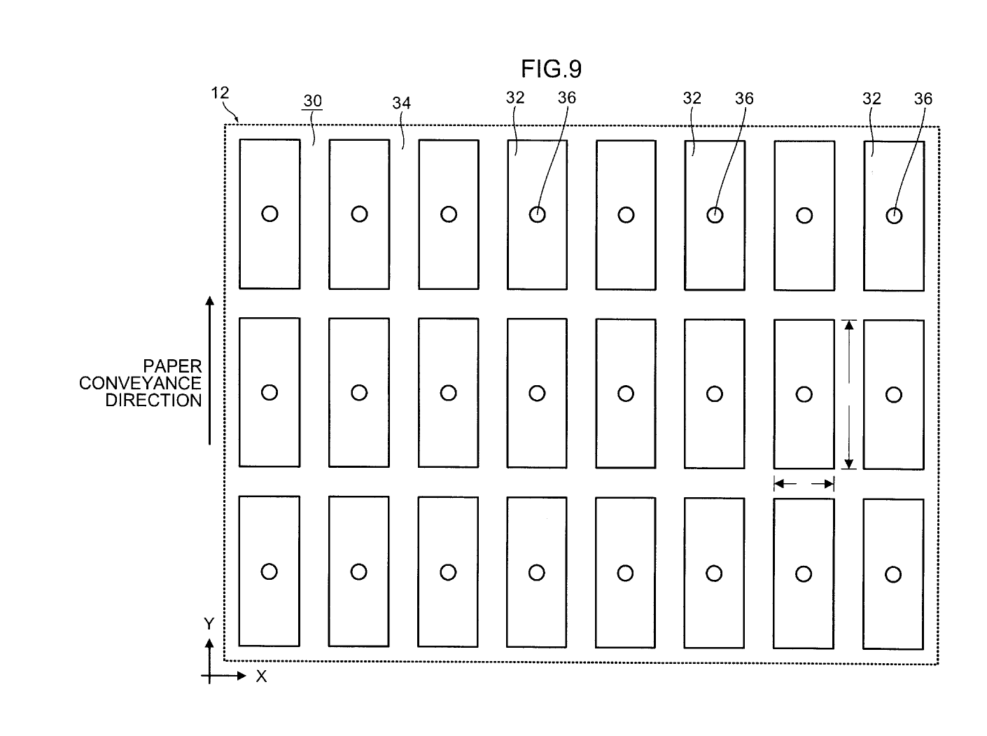

Moreover, in the embodiment described above, the opening shape of the recess sections 32 is a square shape, but as described previously, if the recess sections 32 have a rectangular opening shape, and if the length of the edges parallel to the conveyance direction of the paper is represented by m and the length of the edges in a direction perpendicular to the conveyance direction of the paper P is represented by n (m×n), then these edges are desirably set to a range of 3 [mm]<m≦10 [mm], 3 [mm]<n≦10 [mm] Consequently, as shown in FIG. 9, the opening shape of the recess sections 32 can also be an oblong shape.

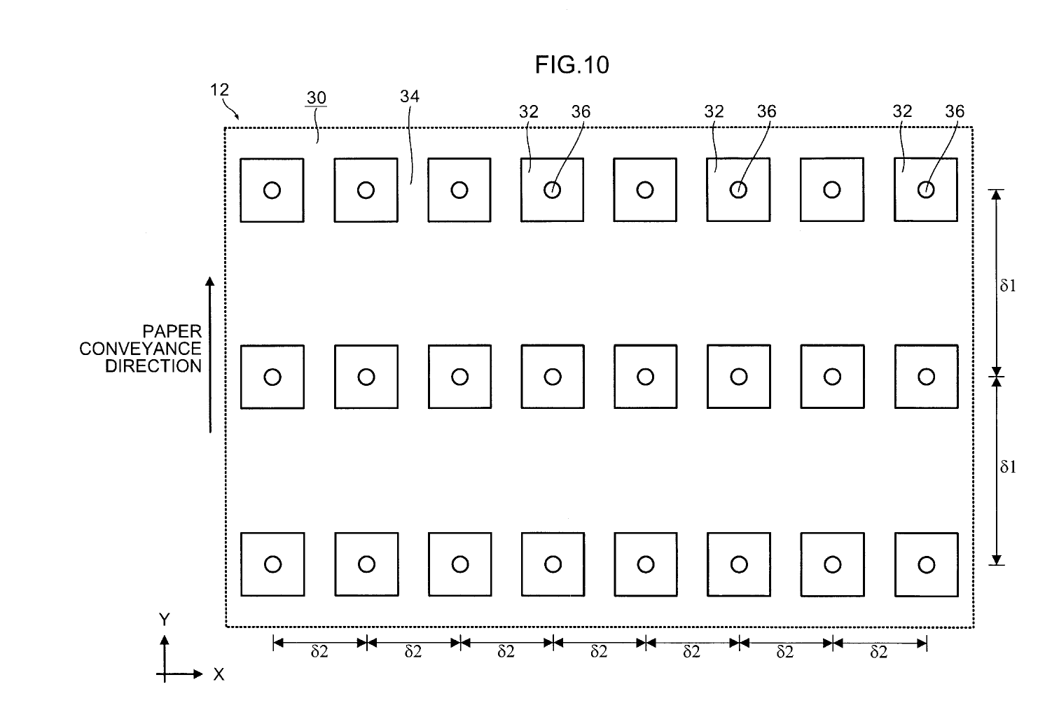

Furthermore, in the present embodiment, a grid-shaped concavoconvex arrangement is formed in the suctioning surface by arranging the recess sections 32 at the same interval apart in the front/rear and left/right in the conveyance direction of the paper P, but the intervals at which the recess sections 32 are arranged do not necessary have to be uniform. The recess sections 32 should be arranged with a fixed regularity. Therefore, as shown in FIG. 10, the arrangement interval 62 of the recess sections 32 in the front/rear direction (the direction parallel to the conveyance direction of the paper P) and the arrangement interval δ1 of the recess sections 32 in the left/right direction (the direction perpendicular to the conveyance direction of the paper P) may be different.

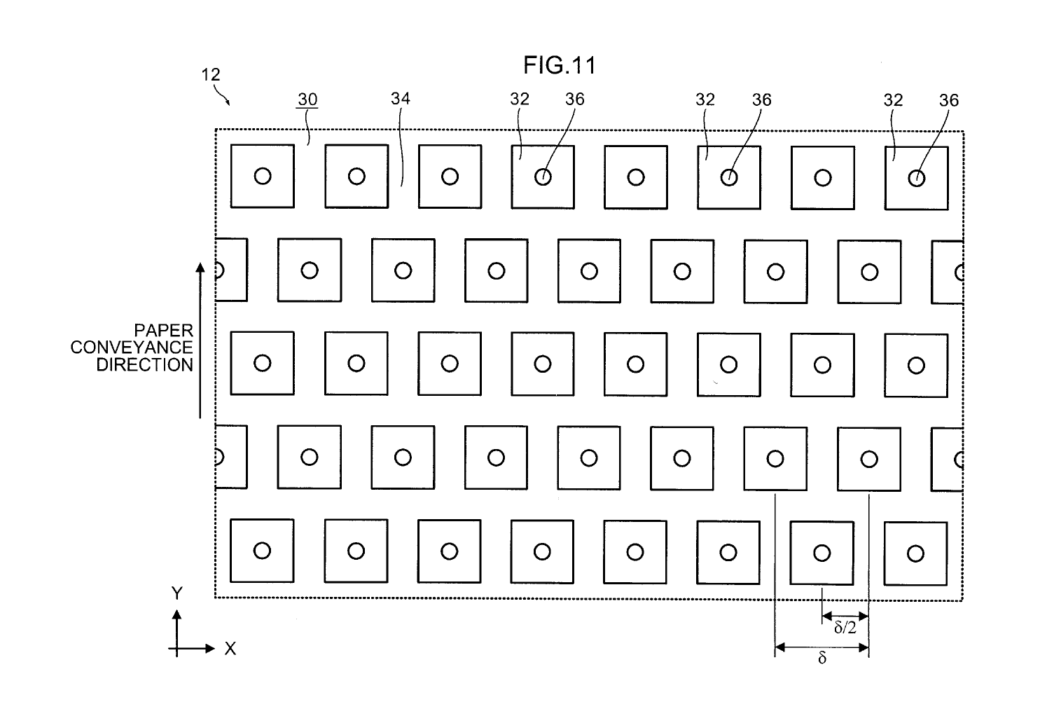

Furthermore, as shown in FIG. 11, it is also possible to adopt a composition in which recess sections 32 are arranged so as to be staggered by half a pitch between each row. In the example shown in FIG. 11, a composition is adopted in which the rows of recess sections 32 aligned in a direction perpendicular to the conveyance direction of the paper P are staggered respectively by half a pitch between each row, but it is also possible to adopt a composition in which rows of recess sections 32 aligned in a direction parallel to the conveyance direction of the paper P are staggered respectively by half a pitch between each row. Furthermore, the amount of stagger does not necessarily have to be half a pitch. By changing the arrangement interval between the recess sections 32 in this way, in the front/rear direction and/or the right/left direction, it is possible to efficiently absorb cockling having a complex period fx (where, for example, fx=f1+f2+f3+ . . . fn).

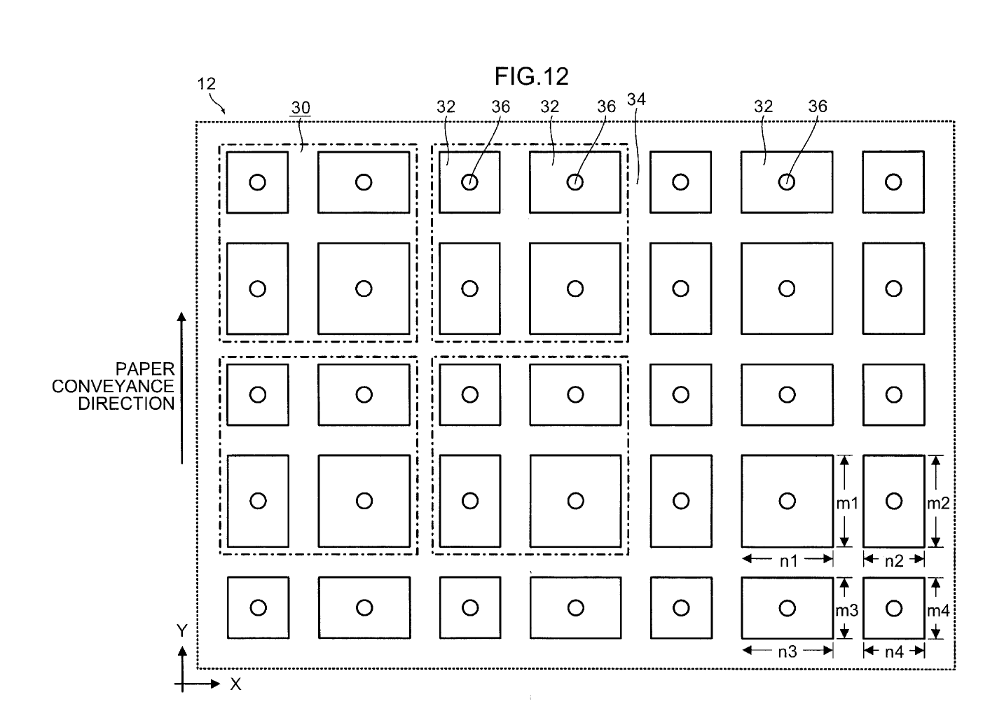

Furthermore, in the embodiment described above, the recess sections 32 all have the same shape, but the shape of the recess sections 32 does not necessarily have to be the same. As shown in FIG. 12, it is also possible to adopt a composition in which recess sections 32 having a plurality of opening shapes are combined. More specifically, the recess sections 32 can be set to have any opening shape or arrangement pitch, provided that they are arranged with a fixed regularity. In the example shown in FIG. 12, a recess section 32 having an m1×n1 opening, a recess section 32 having a m2×n2 opening, a recess section 32 having an m3×n3 opening, and a recess section 32 having a m4×n4 opening are taken as one set, and a concavoconvex arrangement is formed in the suctioning surface by arranging this combination of recess sections 32 at a uniform pitch in the front/rear and left/right directions.

In this way, the recess sections 32 are arranged on the suctioning surface with a fixed regularity, and a prescribed concavoconvex pattern is formed on the suctioning surface.

### <<Further Embodiments of the Suctioning Surface>>

### <Further Embodiment of Suctioning Surface (1)>

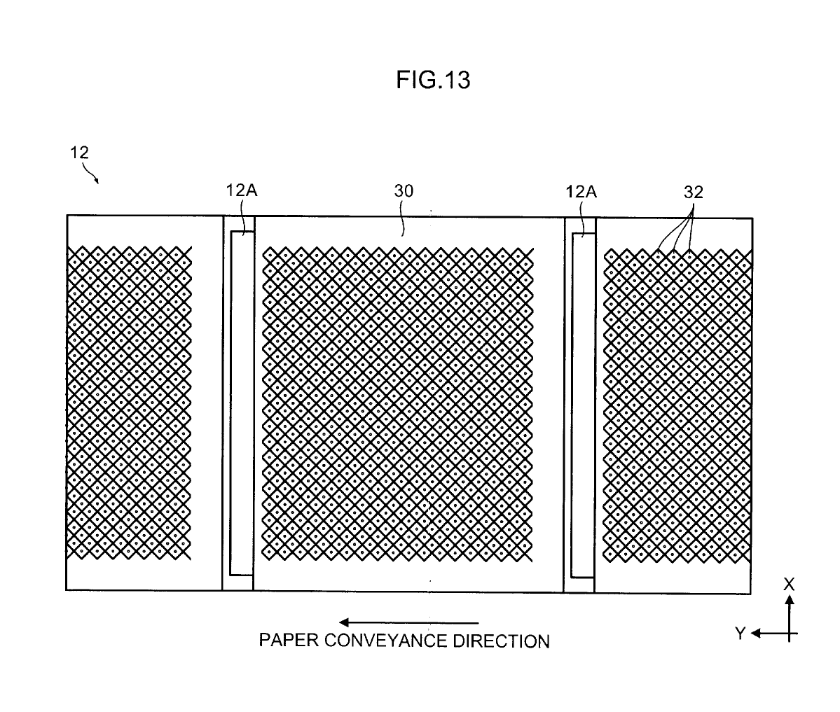

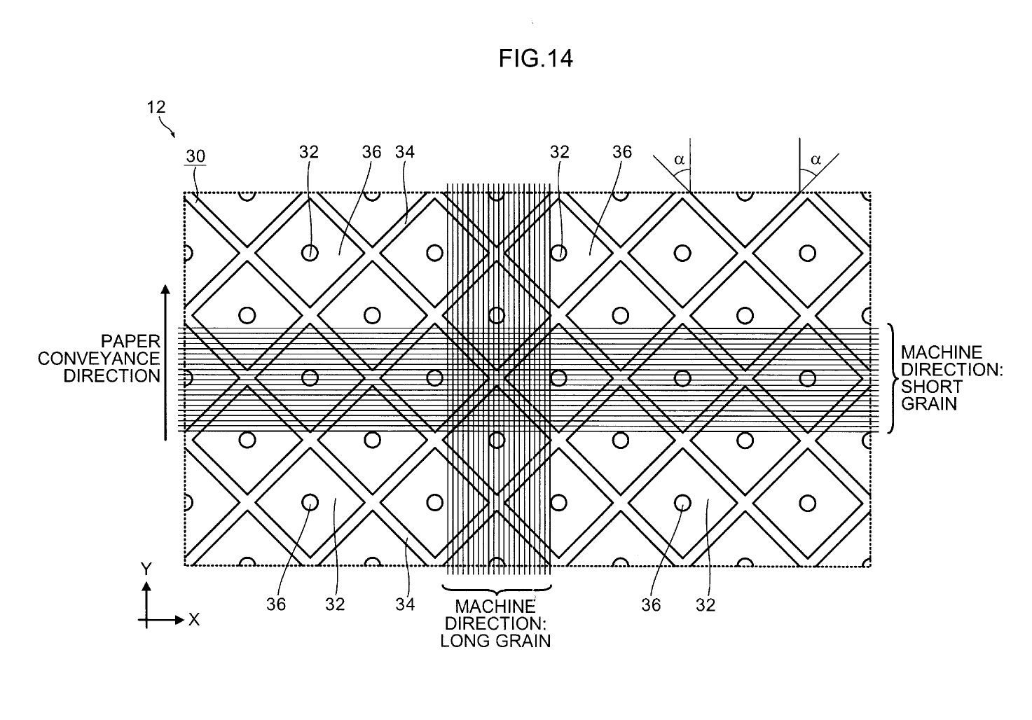

FIG. 13 is an expanded diagram showing a composition of a further embodiment (1) of the circumferential surface (suctioning surface) of a conveyance drum, and FIG. 14 is an enlarged diagram showing an enlarged view of a portion of FIG. 13.

As shown in FIGS. 13 and 14, rectangular recess sections 32 are arranged uniformly at a fixed pitch in the front/rear and left/right in the conveyance direction of the paper P, in the circumferential surface (suctioning surface) 30 of the conveyance drum 12 according to the present embodiment also, thereby forming a concavoconvex arrangement.

The conveyance drum 12 according to the present embodiment differs from the structure of the suctioning surface of the conveyance drum 12 according to the embodiment described above in that the recess sections 32 are arranged in an inclined fashion and the concavoconvex surface is formed in an inclined grid shape.

More specifically, in the conveyance drum 12 according to the embodiment described above, a grid-shaped concavoconvex surface is formed by arranging the respective edges of the recess sections 32 so as to follow the conveyance direction of the paper P and a direction perpendicular to this conveyance direction (a grid-shaped concavoconvex surface is formed by arranging one set of edges of the recess section 32 perpendicularly with respect to the paper conveyance direction of the paper (in parallel with the axis of the conveyance drum 12), and arranging the other set of edges in parallel with the paper conveyance direction (perpendicularly with respect to the axis of the conveyance drum 12)), and in the conveyance drum 12 according to the present embodiment, an inclined grid-shaped concavoconvex surface is formed by arranging the recess sections 32 with the edges of the recess sections 32 at an inclination of a prescribed angle α with respect to the conveyance direction of the paper P (namely, the projecting sections 34 formed in rib shapes are inclined with respect to the conveyance direction of the paper P).

In particular, in the present embodiment, the respective edges of the recess sections 32 are formed so as to be inclined at 45° with respect to the conveyance direction of the paper P.

By forming a concavoconvex surface having an inclined grid shape in the suctioning surface in this way, there ceases to be any region where projecting sections 34 are always present on a straight line (Y) parallel to the conveyance direction of the paper P and a straight line (X) perpendicular to the conveyance direction of the paper P (the projecting sections 34 formed in a rib shape are discontinuous in the X and Y directions), and therefore cockling can be absorbed more efficiently. In other words, as described above, the direction in which cockling occurs varies depending on the machine direction of the paper (long grain or short grain), and is more liable to occur in the direction of the shorter dimension when the paper is in long grain and in the direction of the longer dimension when the paper is in short grain. However, by forming an oblique grid-shaped concavoconvex surface in this way, it is possible to absorb cockling efficiently, irrespectively of the machine direction of the paper P during conveyance (it is possible to prevent the projecting sections 34 formed in a rib shape from being superimposed with the machine direction the paper).

The angle of inclination of the respective edges which constitute the recess sections 32 (the angle of inclination of the projecting sections 34 which are formed in a rib shape) α is desirably set in a range of 0°<α≦45°, and more desirably is set to 45°, as in the present embodiment. By this means, it is possible to minimize the parts where the projecting sections 34 formed in a rib shape are superimposed on the machine direction, and cockling can be absorbed more efficiently.

In the present embodiment, it is possible to form suction holes in the projecting sections 34. By this means, floating and wrinkling of the paper P at the projecting sections 34 can be suppressed effectively.

### <Further Embodiment of Suctioning Surface (2)>

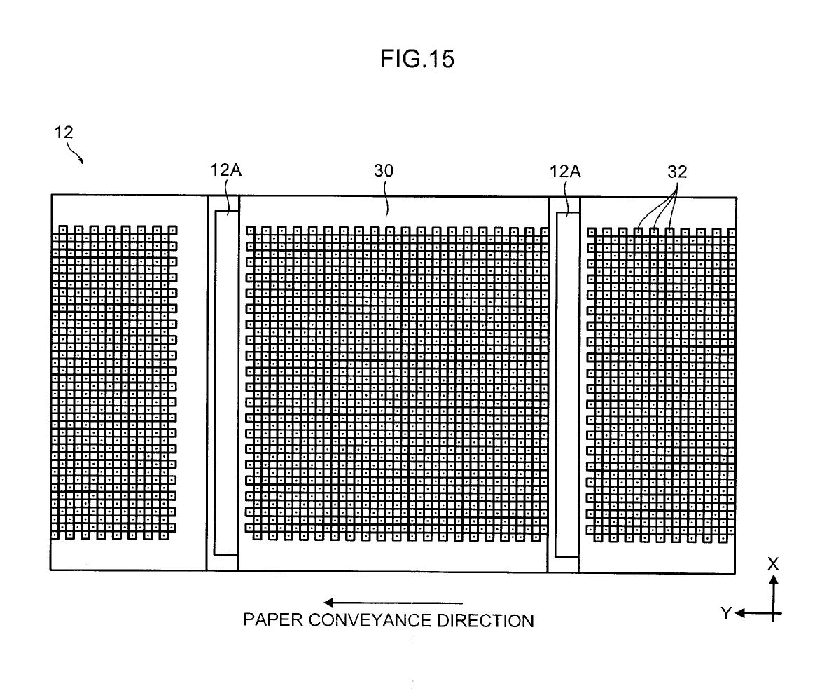

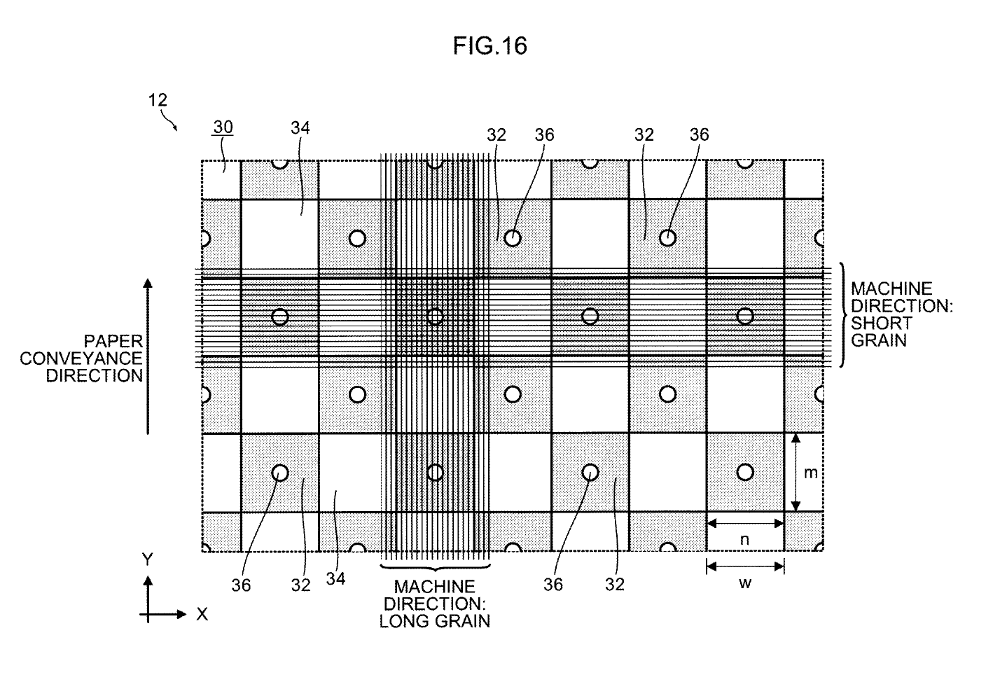

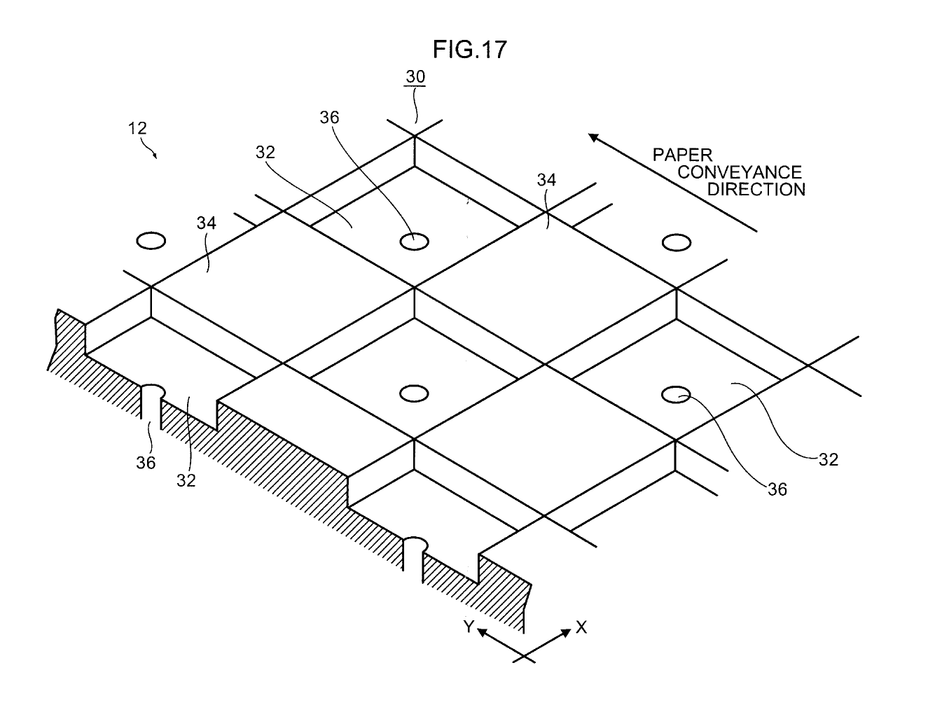

FIG. 15 is an expanded diagram showing a composition of a further embodiment (2) of the circumferential surface (suctioning surface) of a conveyance drum, and FIG. 16 is an enlarged diagram showing an enlarged view of a portion of FIG. 15. Furthermore, FIG. 17 is a perspective diagram of FIG. 16. In FIG. 16, the recess sections 32 are depicted in color, so as to distinguish the recess sections 32 and the projecting sections 34.

As shown in FIGS. 15 to 17, rectangular recess sections 32 are arranged uniformly at a fixed pitch in the front/rear and left/right in the conveyance direction of the paper P, in the circumferential surface (suctioning surface) 30 of the conveyance drum 12 according to the present embodiment also, thereby forming a concavoconvex surface.

However, the conveyance drum 12 according to the present embodiment differs from the structure of the suctioning surface of the conveyance drum 12 according to the embodiment described above in that the recess sections 32 and the projecting sections 34 are formed with the same shape (longitudinal and lateral edges of the same length) and the concavoconvex surface is formed in a checkerboard shape. In other words, the recess sections 32 and the projecting sections 34 are both formed in a rectangular shape (here, a square shape), the recess sections 32 and the projecting sections 34 being arranged in alternating fashion in the front/rear direction thereby forming a checkerboard-shaped concavoconvex surface.

By forming a concavoconvex surface having a checkerboard shape in this way, similarly to the case of the oblique grid-shaped concavoconvex surface described above, there ceases to be any region where projecting sections 34 are always present on a straight line (Y) parallel to the conveyance direction of the paper P and a straight line (X) perpendicular to the conveyance direction of the paper P (the projecting sections 34 are discontinuous in the X and Y directions), and therefore cockling can be absorbed more efficiently.

In the present embodiment, the recess sections 32 and the projecting sections 34 are formed with the same shape (m=n in both cases), but the shapes of the recess sections 32 and the projecting sections 34 do not necessarily have to be the same.

However, as described above, if the edges of the recess sections 32 are m×n, then desirably m and n are set to the range of 3 [mm]<m≦10 [mm], 3 [mm]<n≦10 [mm], and more desirably m and n are set to m=n=5 [mm] This is because, if the length of one edge is no more than 3 [mm], then it is not possible to ensure an amount of distortion capable of absorbing cockling. Furthermore, the width w of the projecting sections 34 is desirably set in a range of 0 [mm]<w≦10 [mm], and more desirably, w m, n, in order to support the paper P (FIG. 15 to FIG. 17 show a case where m=n=w). This is because the amount of absorbed cockling is reduced if the width w of the projecting sections 34 is longer than the lengths m, n of the respective edges of the recess sections 32.

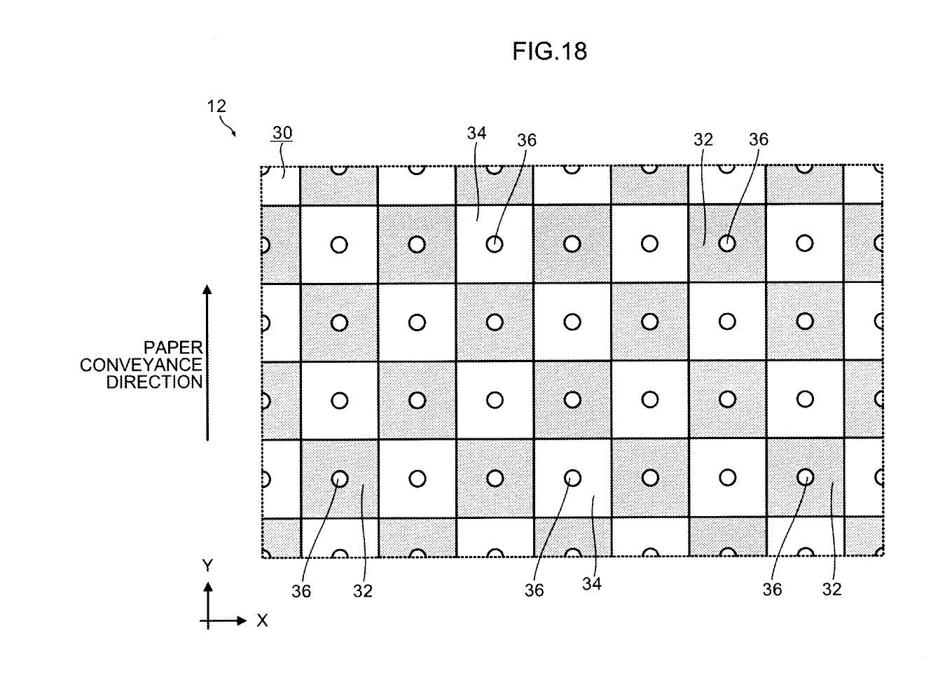

In the present embodiment, as shown in FIG. 18, it is possible to form suction holes 36 in the projecting sections 34. By this means, floating and wrinkling of the paper P at the projecting sections 34 can be suppressed effectively.

### <Further Embodiment of Suctioning Surface (3)>

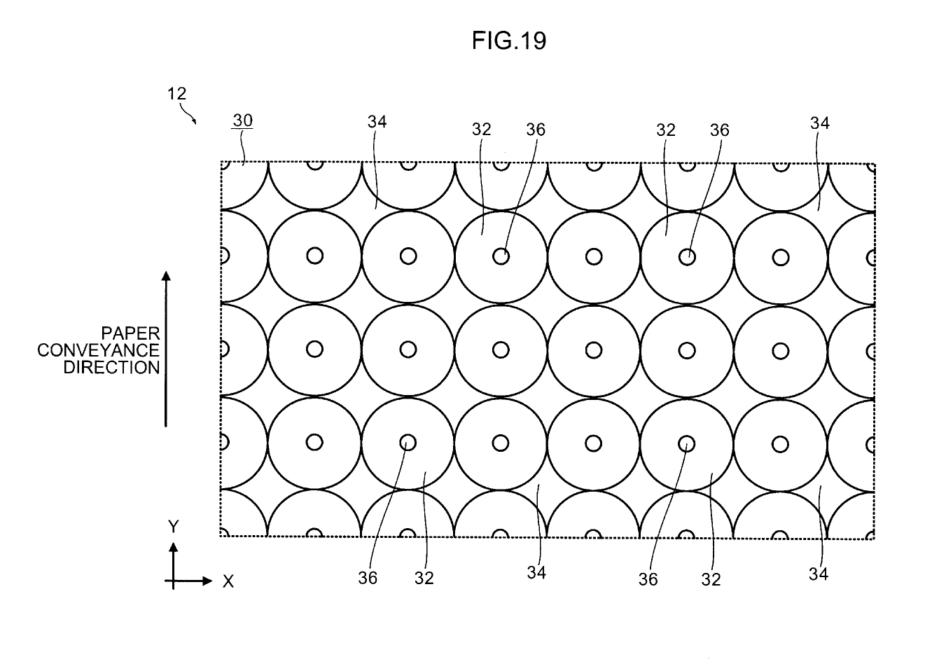

FIG. 19 is an enlarged diagram showing a composition of a further embodiment (3) of the circumferential surface (suctioning surface) of a conveyance drum.

As shown in FIG. 19, circular recess sections 32 are arranged uniformly at a fixed pitch in the front/rear and left/right in the conveyance direction of the paper P, in the circumferential surface (suctioning surface) 30 of the conveyance drum 12 according to the present embodiment also, thereby forming a concavoconvex surface.

In this way, the shape of the recess sections 32 (the shape of the openings) for forming the concavoconvex surface do not necessarily have to be a rectangular shape. Even if a concavoconvex surface is formed by arranging recess sections 32 having circular openings, it is possible to obtain similar beneficial effects.

Furthermore, in the example shown in FIG. 19, a concavoconvex surface is formed by arranging recess sections 32 along straight lines (Y) parallel to the conveyance direction of the paper P and straight lines (X) perpendicular to the conveyance direction of the paper P (a concavoconvex surface is formed by arranging four adjacent recess sections 32 to the front, rear, left and right-hand sides of each recess section 32), but it is also possible to form a concavoconvex surface by arranging recess sections 32 which are aligned in a direction perpendicular to the conveyance direction of the paper P so as to be staggered alternately in the paper conveyance direction (to form a concavoconvex surface by arranging six adjacent recess sections 32 about the perimeter of each recess section 32). Consequently, the projecting sections 34 become even more discontinuous in the X and Y directions, and cockling can be absorbed even more efficiently.

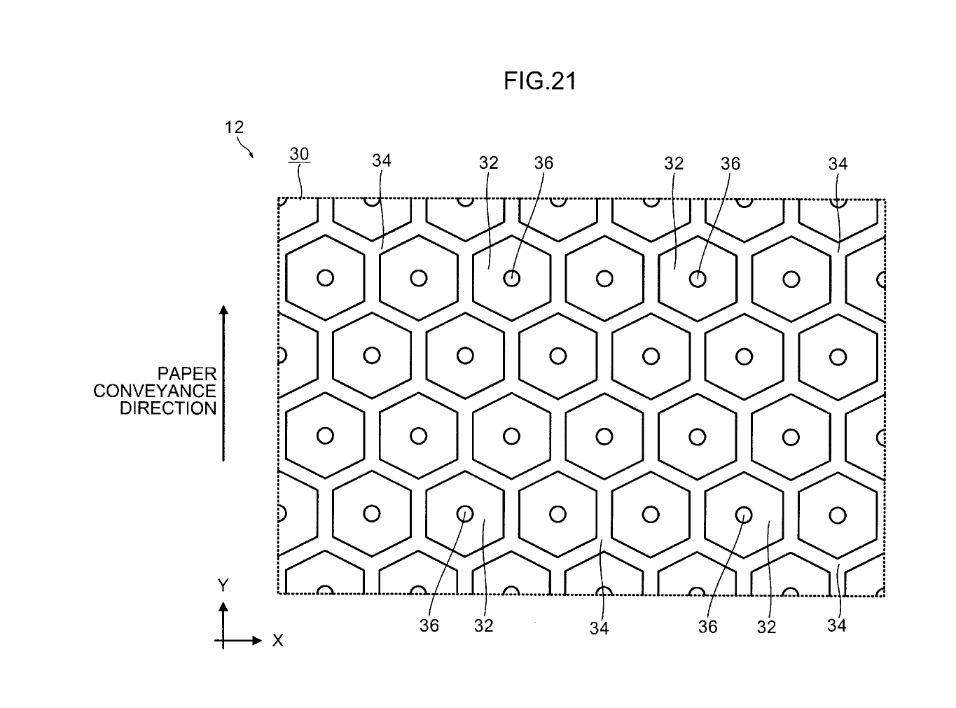

Apart from this, for example, as shown in FIG. 21, it is also possible to form a honeycomb-shaped concavoconvex surface by making the shape of the recess sections 32 a hexagonal shape and arranging the recess sections 32 uniformly at a fixed pitch in the front/rear and left/right in the conveyance direction of the paper P. In this case also, the projecting sections 34 become discontinuous in the X and Y directions, and cockling can be absorbed even more efficiently.

In this way, the shape of the openings of the recess sections 32 is not limited in particular, and it is possible to adopt various shapes.

### <Further Embodiment of Suctioning Surface (4)>

In the series of embodiments described above, a prescribed concavoconvex pattern is formed on the suctioning surface by arranging recess sections in a prescribed arrangement on the suctioning surface.

The concavoconvex arrangement formed on the suctioning surface can also be formed by arranging projecting sections (ribs) in a prescribed arrangement on the suctioning surface. In this case, similar beneficial effects can also be obtained.

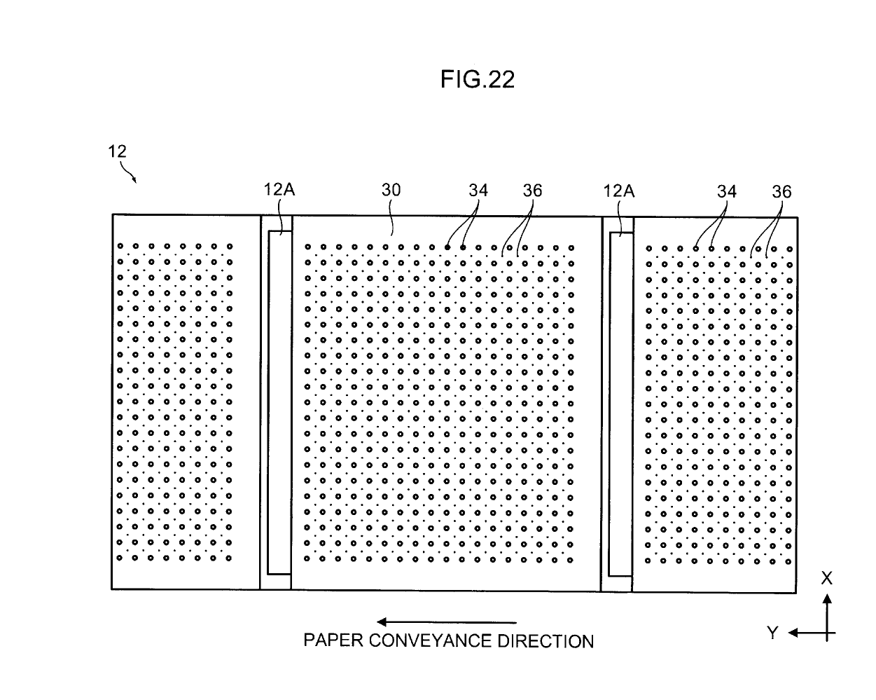

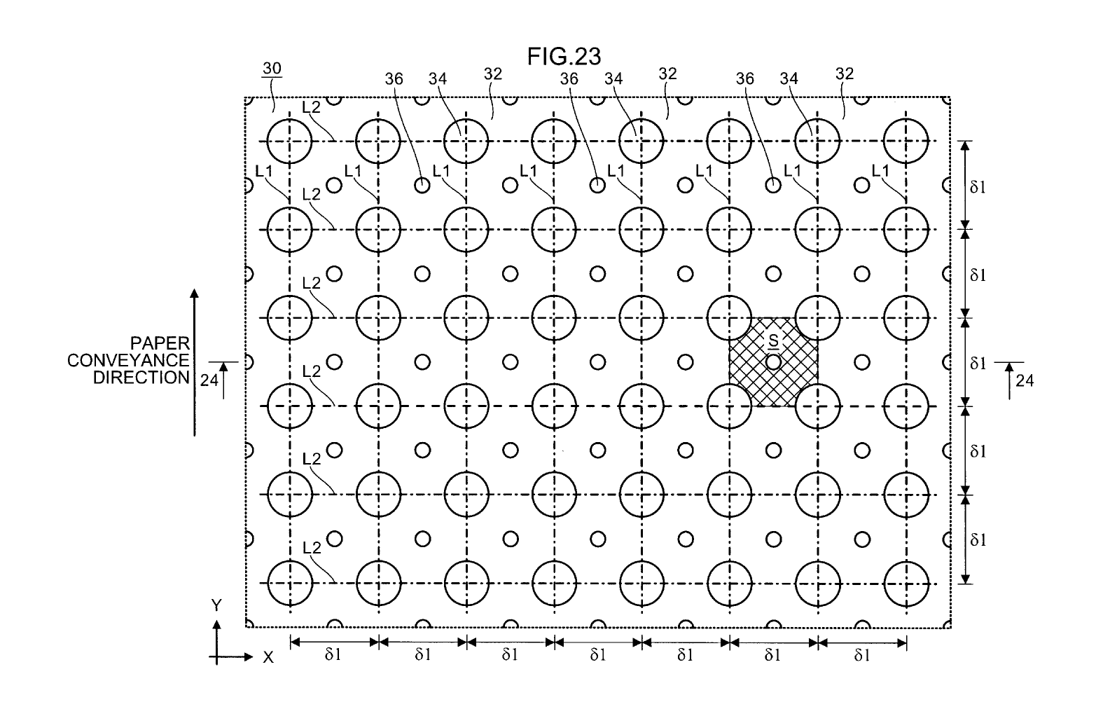

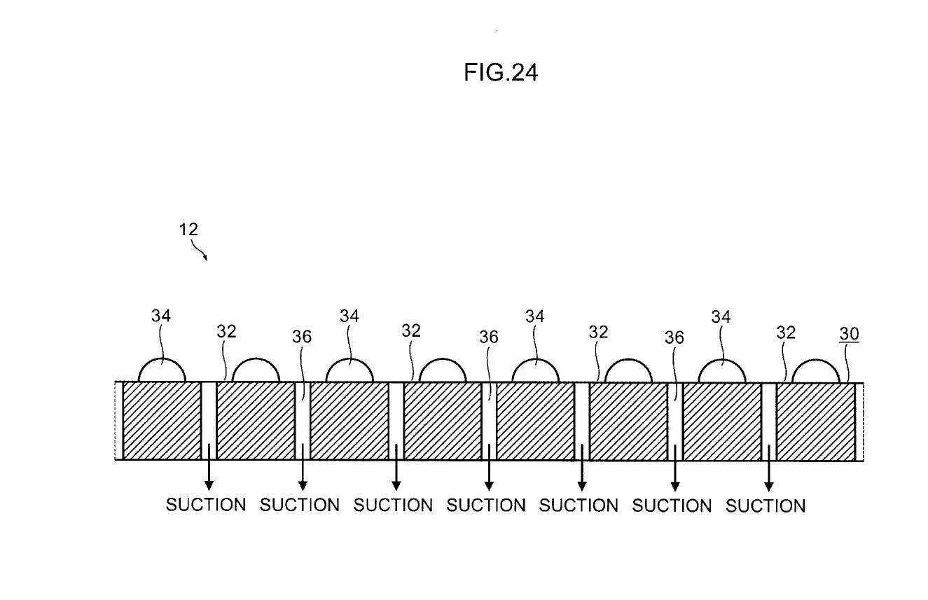

FIG. 22 is an expanded diagram showing a composition of a circumferential surface of a conveyance drum (suctioning surface) in which a concavoconvex arrangement is formed by arranging projecting sections on the circumferential surface. Furthermore, FIG. 23 is an enlarged diagram showing one portion of the FIG. 22, and FIG. 24 is a cross-sectional diagram along 24-24 in FIG. 23.

As shown in FIG. 22 to FIG. 24, a prescribed concavoconvex pattern is formed by arranging hemispherical projecting sections (ribs) 34 regularly on the circumferential surface 30 of the conveyance drum, which is a suctioning surface.

More specifically, as shown in FIG. 22, the hemispherical projecting sections 34 are arranged in a straight line at a fixed pitch (δ1) along the conveyance direction of the paper P, and are also arranged in a straight line at a fixed pitch (δ1) along the direction perpendicular to the conveyance direction of the paper P (namely, along the axial direction of the conveyance drum 12). Accordingly, a uniform concavoconvex pattern is formed in the circumferential surface (suctioning surface) 30.

In this case, the projecting sections 34 are arranged at the intersections between first straight lines L1 and second straight lines L2 which are arranged in a grid shape on the suctioning surface. The first straight lines L1 are straight lines parallel to the conveyance direction of the paper P, and the second straight lines L2 are straight lines perpendicular to the conveyance direction of the paper P. The first straight lines L1 are arranged at a fixed interval 51 apart in the direction perpendicular to the conveyance direction of the paper P, and the second straight lines L2 are arranged at a fixed interval δ1 apart in the conveyance direction of the paper P.

Suction holes 36 for suctioning the paper P are formed in the regions apart from the projecting sections 34, in other words, the regions of the recess sections 32 (flat regions). In particular, in the present embodiment, the suction holes 36 are arranged at a center of each region S which is demarcated by the first straight lines L1 and the second straight lines L2. Consequently, the suction holes 36 are arranged at positions which are equidistant from each of the projecting sections 34 arranged about the periphery thereof. Furthermore, by this means, it is possible to absorb cockling efficiently in the recess sections 32.

The action of the conveyance drum 12 which has a circumferential surface 30 composed as described above is as follows.

Paper P is wrapped about a circumferential surface 30 of the conveyance drum 12, the rear surface of the paper P is held by suction thereon, and the conveyance drum 12 is rotated, thereby conveying the paper P.

The rear surface of the paper P which is wrapped about the circumferential surface 30 of the conveyance drum 12 is supported by the projecting sections 34 of the circumferential surface 30 which is formed as a concavoconvex surface. The rear surface of the paper is suctioned by the recess sections 32 and thereby suctioned and held on the circumferential surface 30.

By holding the paper P by suction on the circumferential surface (suctioning surface) 30 in which a concavoconvex arrangement is formed in this way, during rear surface printing in double-side printing, and the like, it is possible effectively to suppress the occurrence of floating and wrinkling.

In this embodiment, a prescribed concavoconvex pattern is formed in the suctioning surface by arranging projecting sections 34 at the same interval apart in the front/rear and left/right in the conveyance direction of the paper P, but the arrangement pattern of the projecting sections 34 is not limited in particular to this. The projecting sections 34 should be arranged with a fixed regularity.

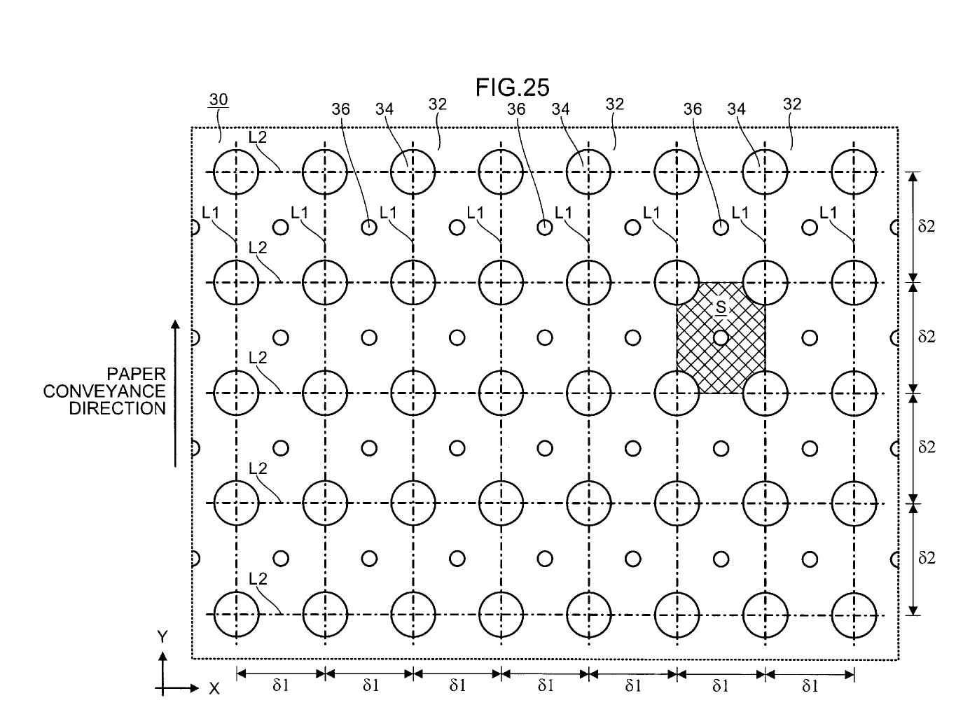

Therefore, as shown in FIG. 25, the arrangement interval δ2 of the projecting sections 34 in the front/rear direction (the direction parallel to the conveyance direction of the paper P) and the arrangement interval δ1 of the projecting sections 34 in the left/right direction (the direction perpendicular to the conveyance direction of the paper P) may be different. In this case, the projecting sections 34 are arranged at the intersection points between first straight lines that are parallel to the conveyance direction of the paper P and second straight lines which are perpendicular to the conveyance direction of the paper P. The first straight lines L1 are arranged at a first interval δ1 apart in the direction perpendicular to the conveyance direction of the paper P, and the second straight lines L2 are arranged at a second interval δ2 apart in the conveyance direction of the paper P. In this case also, desirably, the suction holes 36 are arranged at a center of each region S which is demarcated by the first straight lines L1 and the second straight lines L2.

By changing the arrangement interval between the projecting sections 34 in this way, in the front/rear direction and/or the right/left direction, it is possible to efficiently absorb cockling having a complex period fx (where, for example, fx=f1+f2+f3+ . . . fn).

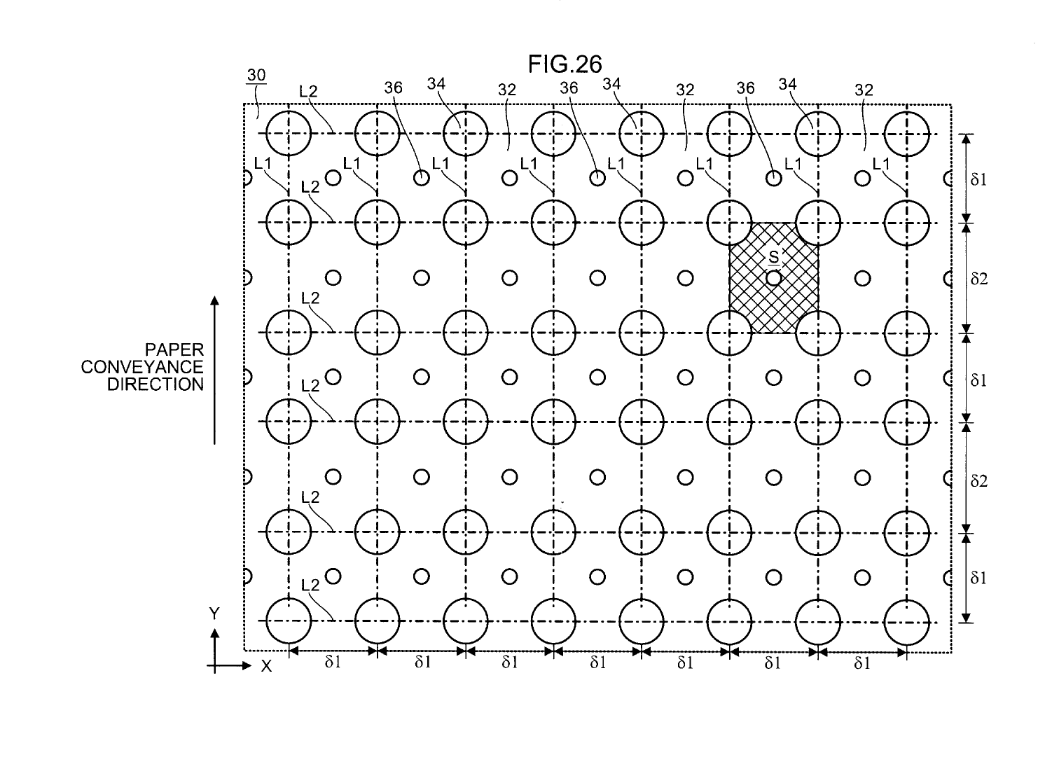

Moreover, it is also possible to arrange the projecting sections by varying the arrangement intervals between the projecting sections 34 in the front/rear direction and/or the left/right direction with a prescribed repetition pattern. For example, as shown in FIG. 26, the projecting sections 34 may be arranged at a uniform arrangement interval apart in the left/right direction, and may be arranged at varying arrangement intervals apart according to a repetition pattern, in the front/rear direction. In the case of the example in FIG. 26, projecting sections 34 are arranged at a fixed arrangement interval δ1 apart in the left/right direction, and projecting sections 34 are arranged according to a repetition pattern of the arrangement interval δ1 and the arrangement interval δ2 in the front/rear direction. In this case, the projecting sections 34 are arranged at the intersection points of first straight lines that are parallel to the conveyance direction of the paper P and second straight lines that are perpendicular to the conveyance direction of the paper P, but the second straight lines L2 are arranged alternately at a first interval δ1 and a second interval δ2 apart in the conveyance direction of the paper P (the first straight lines L1 are arranged at a fixed interval apart (here, the first interval δ1) in the direction perpendicular to the conveyance direction of the paper P). In this case also, desirably, the suction holes 36 are arranged at a center of each region S which is demarcated by the first straight lines L1 and the second straight lines L2.

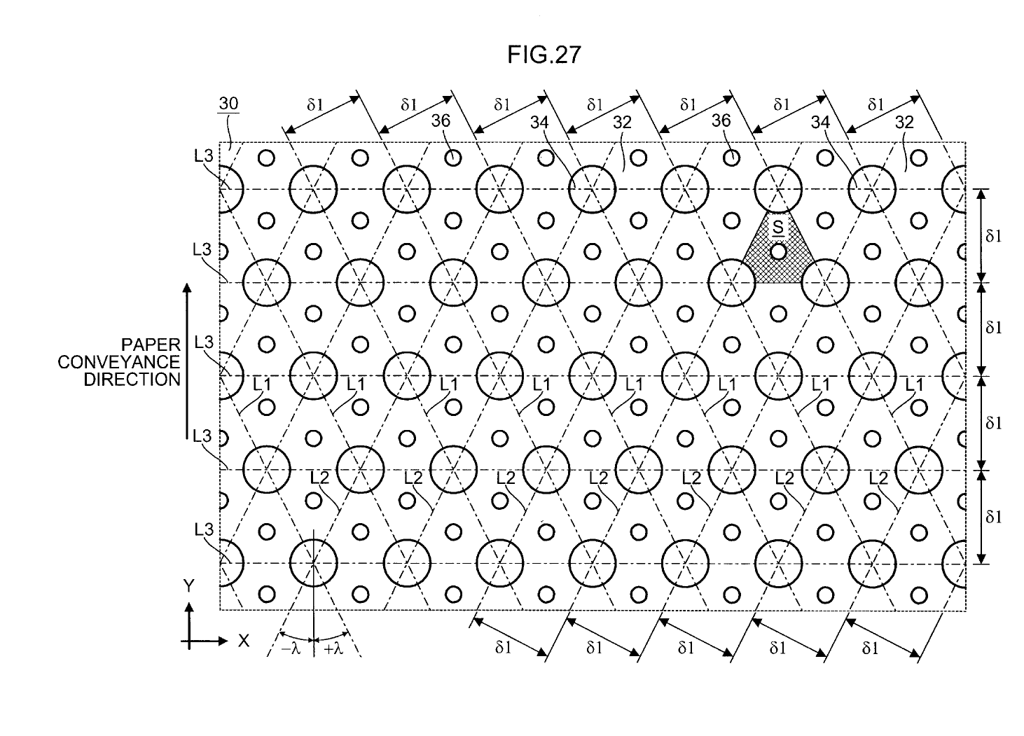

Furthermore, as shown in FIG. 27, it is also possible to adopt a composition in which projecting sections 34 are arranged at intersection points of straight lines which are arranged in an oblique grid shape on the suctioning surface.

In this case, the projecting sections 34 are arranged at the intersections between first straight lines L1 and second straight lines L2 which are arranged in a grid shape on the suctioning surface. The first straight lines L1 are straight lines which are inclined at an angle of λ, degrees with respect to the conveyance direction of the paper P, and the second straight lines L2 are straight lines which are inclined at an angle of −λ, degrees with respect to the conveyance direction of the paper P. The first straight lines L1 are arranged at a fixed interval δ1 apart, and the second straight lines L2 are also arranged at a fixed interval δ1 apart.

In this case also, suction holes 36 are arranged in the regions of the recess sections 32, but the suction holes 36 are desirably arranged in a center of each region S which is demarcated by the first straight lines L1 and the second straight lines L2, and by third straight lines L3. The third straight lines L3 are straight lines perpendicular to the conveyance direction of the paper P, which pass through the intersection points of the first straight lines L1 and the second straight lines L2. The third straight lines L3 are arranged at a uniform interval δ1 apart in the conveyance direction of the paper P. Consequently, in the present embodiment, the regions S demarcated by the first straight lines L1, the second straight lines L2 and the third straight lines L3 each have an equilateral triangular shape, and a suction hole 36 is arranged at a center of each of these equilateral triangular-shaped regions S.

In this way, the projecting sections 34 are arranged on the suctioning surface with a fixed regularity, thereby forming a prescribed concavoconvex pattern on the suctioning surface. Moreover, if the arrangement interval between the projecting sections 34 is varied in the front/rear direction and/or the left/right direction, then it is possible to efficiently absorb cockling having a complex period fx.

In the series of embodiments described above, the shape of the projecting sections 34 is a hemispherical shape, but the three-dimensional shape of the projecting sections 34 is not limited to this.

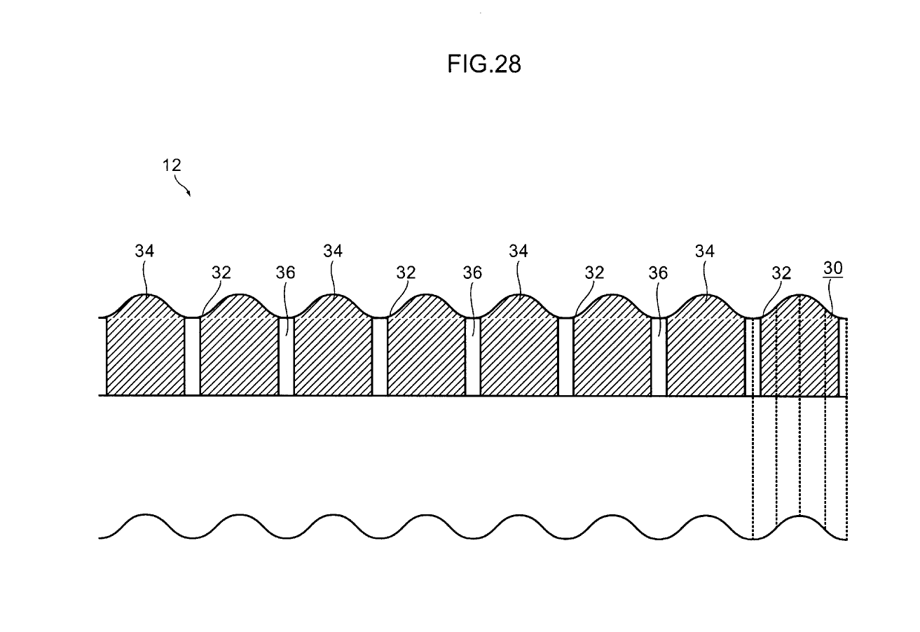

For example, as shown in FIG. 28, the projecting sections 34 (or the recess sections 32) may be formed in such a manner that the cross-sectional shape (outer line shape) of the concavoconvex arrangement formed in the suctioning surface 30 is a sinusoidal shape.

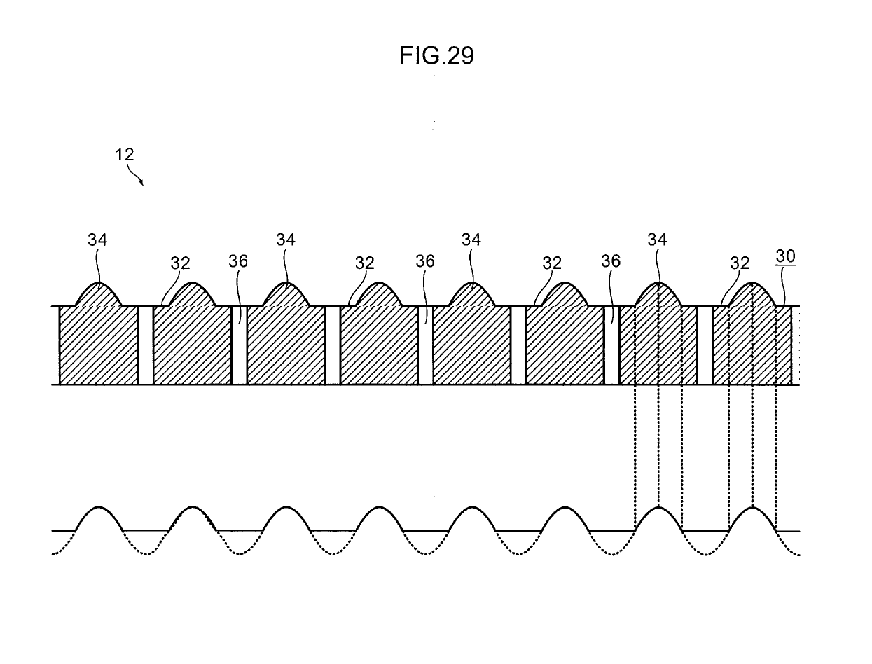

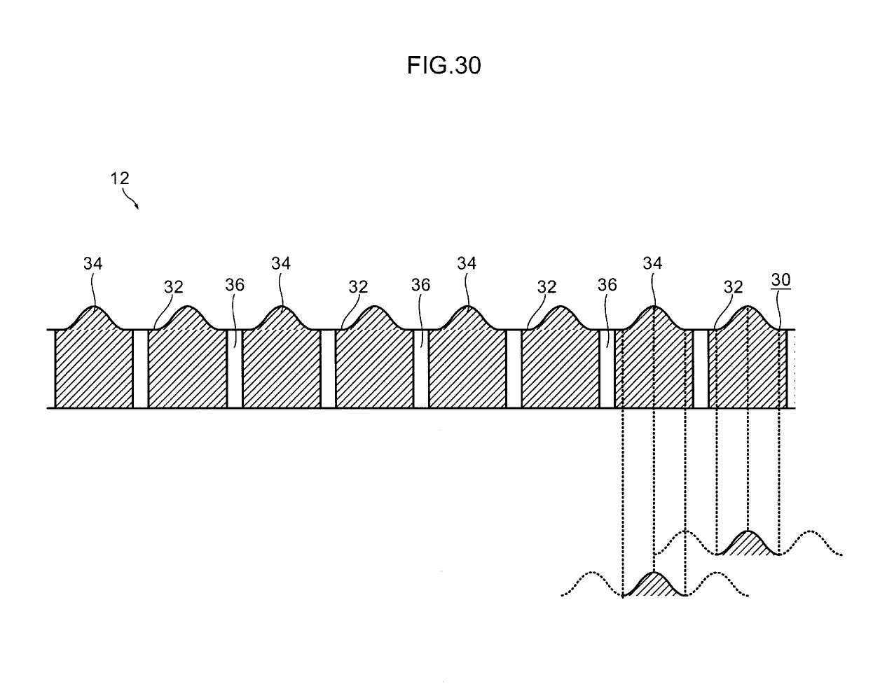

Moreover, as shown in FIG. 29 and FIG. 30, the projecting sections 34 may also be formed in such a manner that the cross-sectional shape (outer line shape) forms a portion of a sinusoidal wave. FIG. 29 shows an example where projecting sections 34 having a cross-sectional shape that is the same as a portion (upper portion) of a sinusoidal wave are formed in the suctioning surface 30 at the same period as that sinusoidal wave. Furthermore, FIG. 30 shows an example where projecting sections 34 having the same cross-section as a portion of a sinusoidal wave are arranged in the suctioning surface 30 at a prescribed interval apart. In either of these cases, the projecting sections 34 have the same shape in any cross-section perpendicular to the suctioning surface 30 (a shape formed by rotating an extracted portion of a sinusoidal wave).

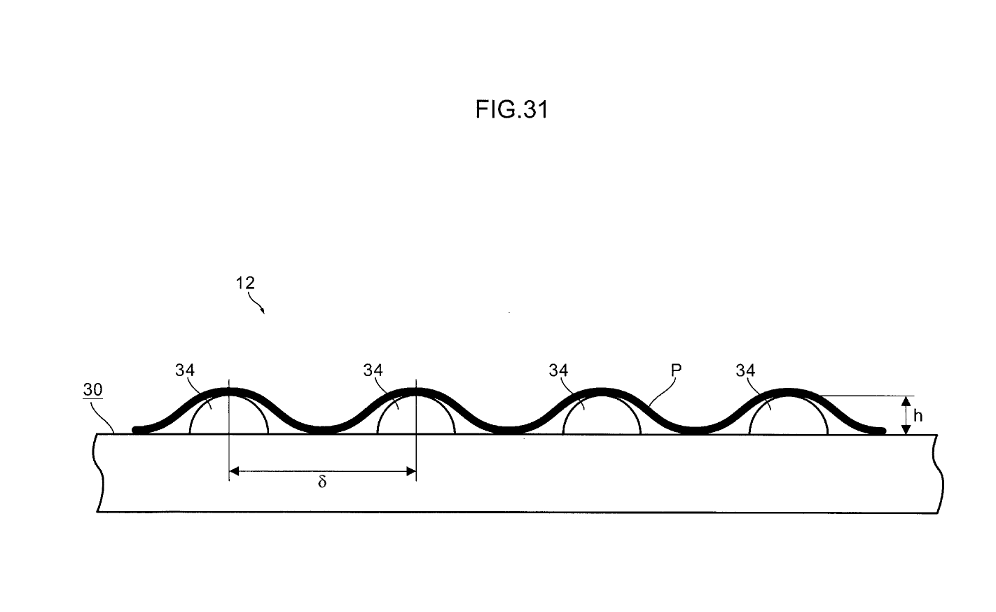

As shown in FIG. 31, the height h of the projecting sections 34 and the arrangement interval δ therebetween is set by taking account of the absorption of cockling, but when using printing paper, it is desirable to set the height h to no more than 0.3 mm and to set the arrangement interval δ to 2 to 9 mm Consequently, it is possible effectively to absorb cockling in the recess sections, and the paper P can be conveyed without giving rise to wrinkling or floating.

Furthermore, the suction holes 36 should be arranged regularly in the regions of the recess sections 32. Consequently, it is possible to adopt a composition in which a plurality of suction holes 36 are arranged in each region S.

Furthermore, in the series of embodiments described above, suction holes 36 are arranged only in the region of the recess sections 32, but it is also possible to arrange suction holes in the projecting sections 34 as well. In this case, for example, suction holes are arranged in a center of the projecting sections 34.

### <<Further Embodiments of Inkjet Recording Apparatus>>

### <Further Embodiment of Conveyance Device (1)>

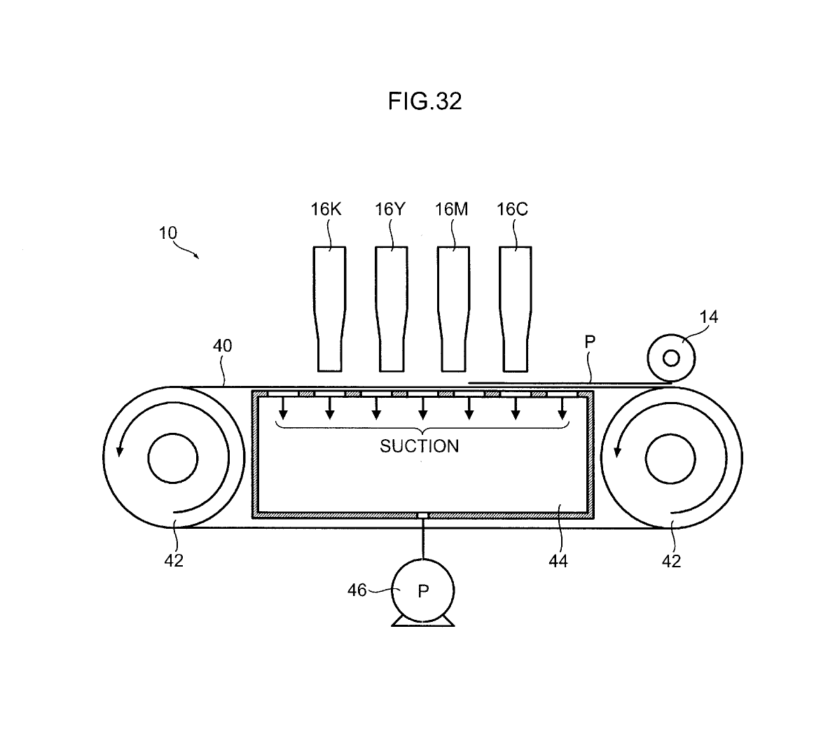

In the embodiments described above, a case is described in which the present invention was applied to an inkjet recording apparatus which conveys paper P by a drum, but the application of the present invention is not limited to this. The invention can also be applied similarly to any inkjet recording apparatus having a composition in which paper P is conveyed by suctioning, and similar beneficial effects can be obtained in this case. For instance, as shown in FIG. 32, it is also possible to apply the present invention to an inkjet recording apparatus which conveys paper P on a belt. If paper P is conveyed on a belt, then the paper P is conveyed while being held by suction on the circumferential surface of the conveyance belt 40. Consequently, in this case, a concavoconvex arrangement as described above is formed in the circumferential surface (suctioning surface) of the conveyance belt 40. Consequently, it is possible to convey the paper P without the occurrence of floating or wrinkling, even in the case of conveyance by a belt.

In a conveyance device which conveys paper P by a belt, a conveyance belt 40 is formed in an endless fashion and wrapped about pulleys 42, so as to form a prescribed conveyance path. The pulleys 42 are driven by a motor (not illustrated) to rotate. Consequently, the conveyance belt 40 travels and the suctioning surface moves.

A suction chamber 44 is arranged on the inner side of the conveyance belt 40. The suction chamber 44 is connected to a suctioning apparatus (such as a vacuum pump) 46, and air inside the suction chamber is sucked out by this suctioning apparatus 46. Air is suctioned from the suction holes (not illustrated) formed in the suctioning surface, when the conveyance belt 40 passes over this suction chamber 44. Consequently, the paper P loaded on the suctioning surface is held by suction on the suctioning surface.

### <Further Embodiment of Conveyance Device (2)>

In the embodiments described above, when the paper P is transferred from the conveyance device in a previous stage to the conveyance drum 12, the paper P is transferred directly to the conveyance drum 12, but in transferring the paper P to the conveyance drum 12 (in suctioning the paper P onto the circumferential surface of the conveyance drum 12), it is possible to suppress the occurrence of wrinkling or floating more effectively by applying a back tension to the paper P while transferring the paper P to the conveyance drum 12. More specifically, by applying a back tension to the paper P to the upstream side of the suctioning surface which has a concavoconvex arrangement, cockling is dispersed into the whole of the paper and cockling can be absorbed more efficiently by the suctioning surface having a concavoconvex arrangement.

The back tension can be applied by wrapping the paper P about the circumferential surface of the conveyance drum 12 while suctioning the front surface or the rear surface of the paper P.

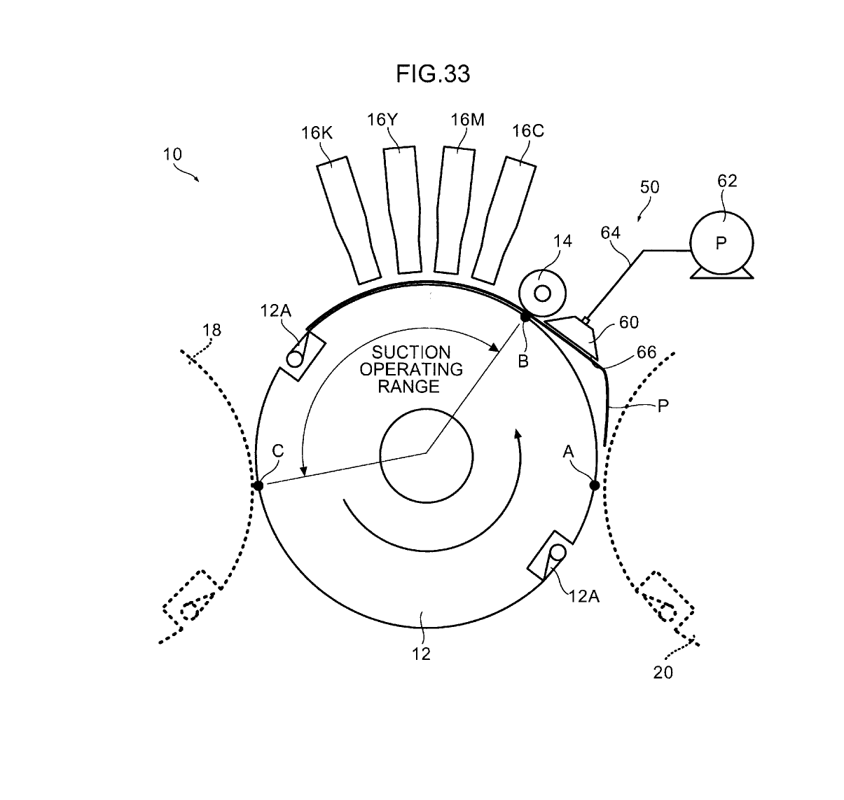

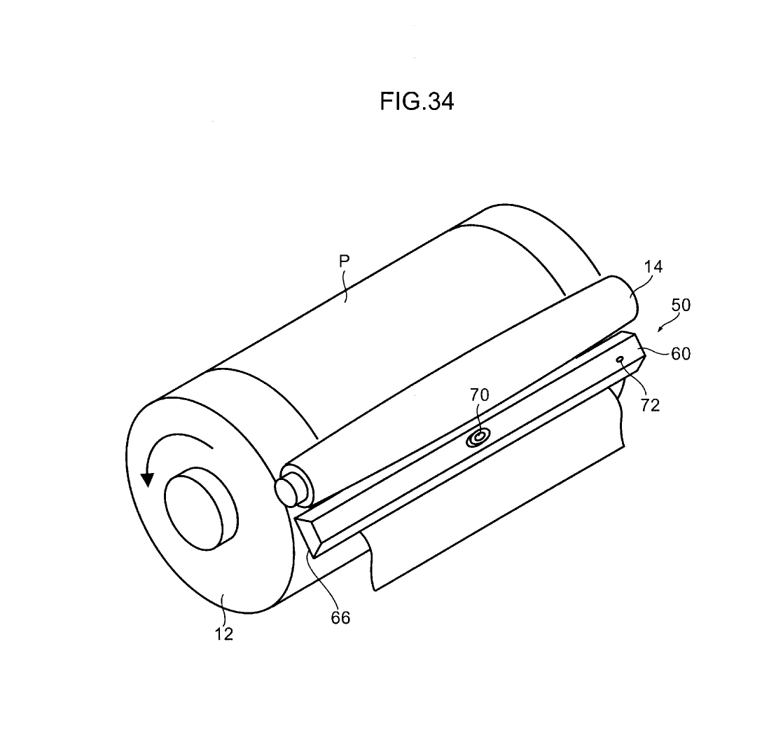

FIG. 33 is a general schematic drawing showing one example of an inkjet recording apparatus which incorporates a back tension application apparatus. Furthermore, FIG. 34 is a perspective diagram showing the general composition of a back tension application apparatus.

This back tension application apparatus 50 applies a back tension to the paper P by holding the front surface of the paper P by suction on a prescribed suction holding surface through suctioning the front surface of the paper P at a position immediately before the paper P conveyed by the conveyance drum 12 is pressed by the pressing roller 14 (at a position immediately before the paper P enters in between the conveyance drum 12 and the pressing roller 14).

The back tension application apparatus 50 is principally constituted by a suction unit 60 and a vacuum pump 62.

The suction unit 60 is formed in a hollow box shape having a trapezoidal cross-section parallel to the conveyance direction of the paper P (a divergent box shape), and is formed so as to correspond to the paper width. Therefore, the width (the width in the direction perpendicular to the conveyance direction of the paper P) is formed to be substantially the same as the width of the conveyance drum 12.

The surface on the image recording drum side of the suction unit 60 (the lower surface) is formed to be flat, and the surface on the image recording drum side (the lower surface) forms a suction holding surface 66 which suctions and holds the front surface of the paper P (printing surface).

The suction unit 60 is provided in the vicinity of the pressing roller 14, and the suction holding surface 66 is arranged so as to follow a tangent T to the conveyance drum 12 at the installation point of the pressing roller 14 (the point of contact between the pressing roller 14 and the outer circumferential surface of the conveyance drum 12 (in the present embodiment, the suctioning start position B)) (in other words, the suction holding surface 66 is arranged in such a manner that the installation point of the pressing roller 14 is situated on the extension line of the suction holding surface 66).

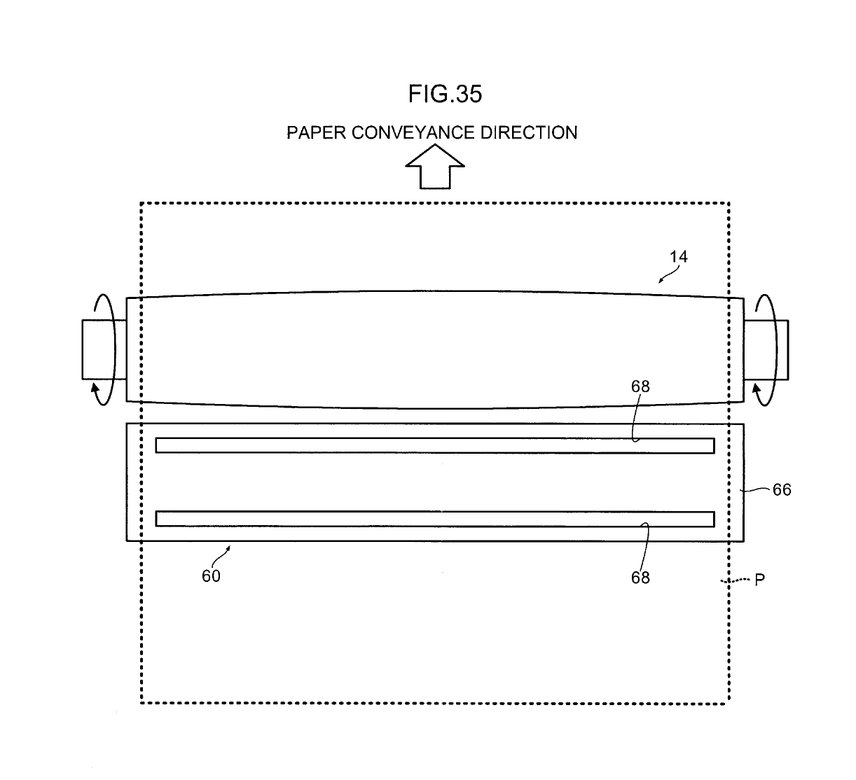

FIG. 35 is a lower surface diagram of the suction unit (a plan diagram of the suction holding surface). As shown in FIG. 35, suction holes 68 are formed in the suction holding surface 66. The suction holes 68 are formed in a slit shape and are formed in a direction perpendicular to the conveyance direction of the paper P (namely, in parallel with the axis of the pressing roller 14). The suction holes 68 are connected to the interior (hollow portion) of the suction unit which is formed in a hollow centered shape.

The number of suction holes 68 is not limited in particular. The number of suction holes 68 is set appropriately in accordance with the length of the suction holding surface 66 in the front/rear direction (the conveyance direction of the paper P), and the like. In the present embodiment, two suction holes 68 are formed at the front and rear in the conveyance direction of the paper P.

A suction port 70 is formed in a central portion of the upper surface of the suction unit 60 (the surface opposite to the suction holding surface 66). The suction port 70 is connected to the interior (hollow portion) of the suction unit 60 which is formed in a hollow centered shape. By suctioning air from the suction port 70, air is suctioned from the suction holes 68 which are formed in the suction holding surface 68.

Furthermore, a vacuum prevention hole 72 is formed in the upper surface of the suction unit 60. The vacuum prevention hole 72 prevents the application of excessive suction force by allowing the pressure inside the suction unit 60 to escape. Since the vacuum prevention hole 72 serves to prevent the application of an excessive suction force in this way, then the position, size and number thereof are adjusted appropriately within a range meeting this object.

The vacuum pump 62 is connected to the suction port 70 of the suction unit 60 via a pipe 64. By driving this vacuum pump 62, the interior (hollow center portion) of the suction unit 60 is suctioned to a negative pressure via the suction holes 68 formed in the suction holding surface 66.

The suctioning from the suction holes 68 is stopped by halting the driving of the vacuum pump 62. Therefore, by controlling (switching on and off) the driving of the vacuum pump 62, it is possible to control the on/off switching of the suctioning from the suction holes 68, and on/off switching of the application of back tension can be controlled. The driving of the vacuum pump 62 is controlled by a control apparatus (not illustrated) of the inkjet recording apparatus 10.

The back tension application apparatus 50 is composed as described above. The action of this back tension application apparatus 50 is as described above.

The paper P is transferred from the conveyance device (conveyance drum 20) of the preceding stage to the conveyance drum 12. The conveyance drum 12 receives the paper P from the conveyance device of the preceding stage at a prescribed position A. The paper P is received by gripping the leading end of the paper P with a gripper 12A. The conveyance drum 12 receives the paper P while rotating.

The paper P of which leading end has been gripped by the gripper 12A is conveyed by rotation of the conveyance drum 12. The surface (printing surface) is then pressed by the pressing roller 14 at the installation position of the pressing roller 14, thereby causing the paper P to make tight contact with the outer circumferential surface of the conveyance drum 12.

Here, a back tension application apparatus 50 is provided before the pressing roller 14 (to the upstream side in the conveyance direction of the paper P), in the inkjet recording apparatus according to the present embodiment. The front surface of the paper P is suctioned by the back tension application apparatus 50 at a position immediately before entering into the installation position of the pressing roller 14, thereby applying a back tension. By applying this back tension, the paper P is stretched in the conveyance direction and deformation (distortion) occurring in the paper P is removed. When the paper P enters in between the pressing roller 14 and the conveyance drum 12 while this back tension is applied, it is possible for the paper P to wrap about the circumferential surface of the conveyance drum 12 without giving rise to wrinkling or floating.

Since the conveyance drum 12 performs a suctioning operation from the installation point of the pressing roller 14, then the rear surface of the paper P is suctioned from the suction holes formed in the outer circumferential surface of the conveyance drum 12, simultaneously with being pressed by the pressing roller 14, and the paper P is thereby suctioned and held on the outer circumferential surface of the conveyance drum 12. The paper P then passes the installation unit of the inkjet heads 16C, 16M, 16Y and 16K, and an image is recorded on the front surface thereof.

In this way, by wrapping the paper P about the circumferential surface of the conveyance drum 12 while applying a back tension, it is possible to wrap the paper P about the circumferential surface of the conveyance drum 12 without giving rise to wrinkling or floating.

### <Further Embodiment of Conveyance Device (2)>

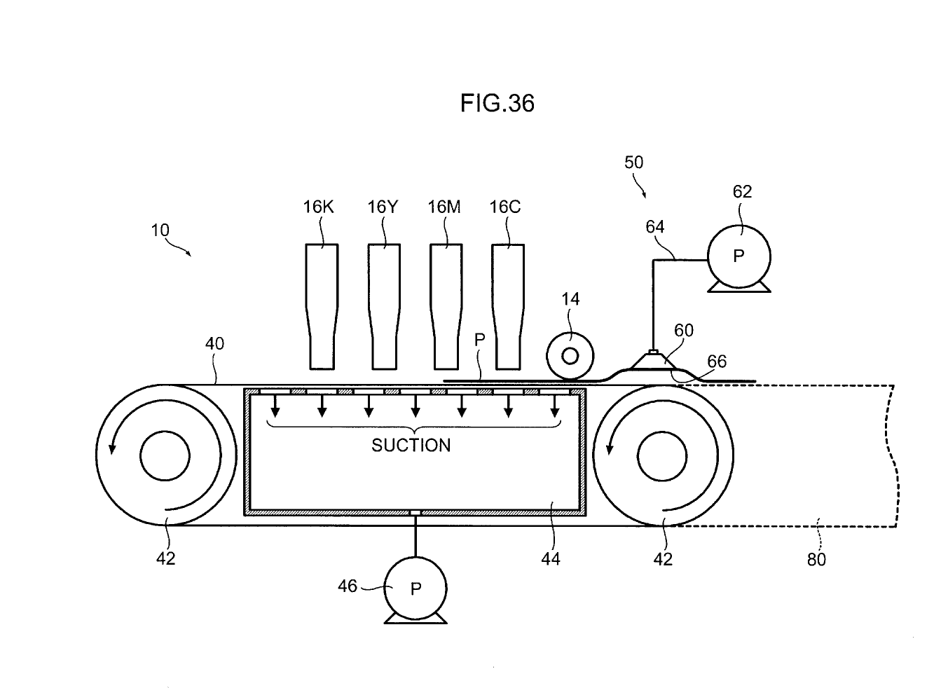

FIG. 36 is a general schematic drawing of a case where a back tension application apparatus is incorporated into the inkjet recording apparatus which conveys paper on a belt.

As shown in FIG. 36, it is also possible to incorporate a back tension application apparatus 50 in cases where the paper P is conveyed on a belt, and similar action and beneficial effects can be obtained.

A desirable composition is one in which a back tension is applied at a position immediately before suctioning the circumferential surface of the conveyance belt 40, when conveying paper P on a belt also. In the example shown in FIG. 33, a pressing roller 14 is installed at a position where suctioning by the suction chamber 44 starts, and a suction unit 60 of the back tension application apparatus 50 is provided at a position immediately before this pressing roller 14 (a position immediately before the paper P enters in between the conveyance belt 40 and the pressing roller 14). Consequently, the front surface of the paper P which has been transferred from the conveyance device of the preceding stage (conveyance belt) 76 to the conveyance belt 40 is suctioned at a position immediately before entering in between the conveyance belt 40 and the pressing roller 14, and a back tension is applied to the paper P.

### <Further Embodiment of Conveyance Device (3)>

It is also possible to adopt a composition in which a back tension is applied by suctioning the rear surface of the paper P.

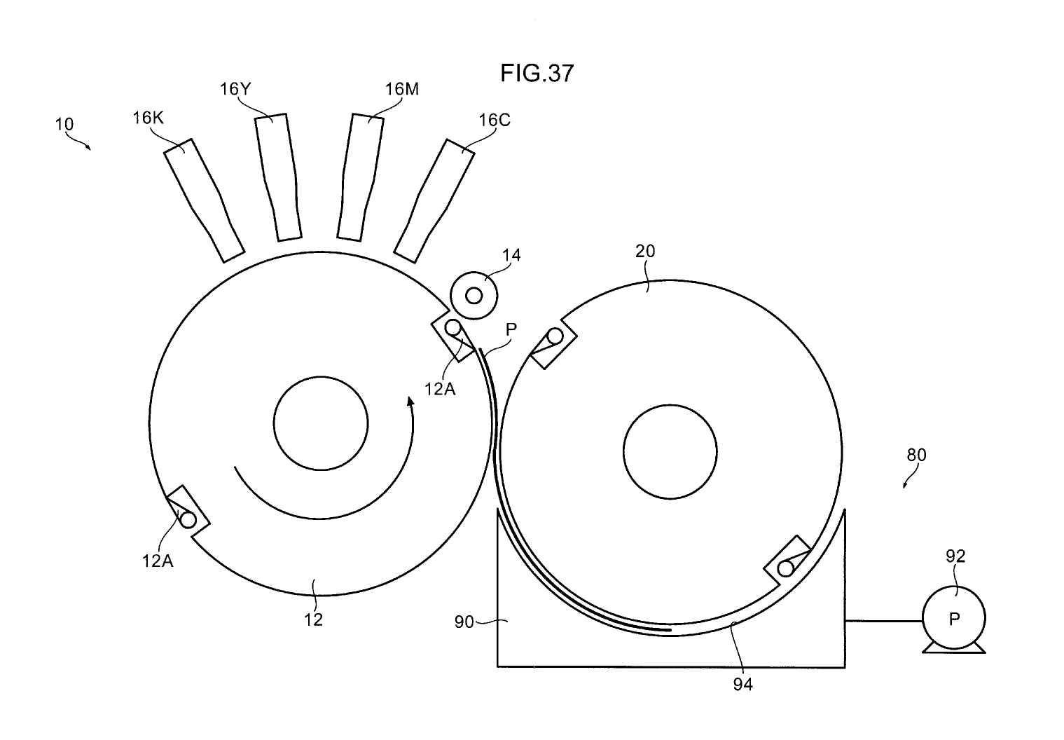

FIG. 37 is a general schematic drawing of a back tension application apparatus which applies a back tension by suctioning a rear surface of paper.

This back tension application apparatus 80 applies back tension to the paper P by suctioning the rear surface of the paper P which is conveyed by the conveyance drum 20 of the preceding stage.

The back tension application apparatus 80 is principally constituted by a suction unit 90 and a vacuum pump 92.

The suction unit 90 is disposed below the conveyance drum 20 of the preceding stage and suctions the rear surface of the paper P which is conveyed by the conveyance drum 20 of the preceding stage. This suction unit 90 is formed in a hollow box shape and is formed so as to correspond to the paper width. Therefore, the width of the suction unit 90 (the width in the direction perpendicular to the conveyance direction of the paper P) is formed to be substantially the same as the width of the conveyance drum 20 of the preceding stage.

The upper surface portion of the suction unit 90 is formed in a circular arc shape. The upper surface portion of this suction unit 90 constitutes a suction holding surface 94 which suctions and holds the paper. The suction holding surface 94 is formed so as to follow the conveyance path of the paper P which is conveyed by the conveyance drum 20 of the preceding stage. Therefore, the suction holding surface 94 is formed along a circular arc centered on the axis of rotation of the conveyance drum 20 of the preceding stage. The paper P which is conveyed by the conveyance drum 20 of the preceding stage is conveyed while rubbing over the suction holding surface 94 of the suction unit 90.

A plurality of suction holes (not illustrated) are formed in the suction holding surface 94. The suction holes are formed in a circular shape, for instance, and are arranged over the whole of the suction holding surface 94 in a fixed arrangement pattern. The suction holes are connected to the interior of the suction unit 90 (the hollow center portion).

The vacuum pump 92 is connected to the suction port 96 of the suction unit 90 via a pipe. By driving this vacuum pump 92, the interior (hollow center portion) of the suction unit 90 is suctioned to a negative pressure via the suction holes formed in the suction holding surface 94.

The suctioning from the suction holes is stopped by halting the driving of the vacuum pump 92. Therefore, by controlling (switching on and off) the driving of the vacuum pump 92, it is possible to control the on/off switching of the suctioning from the suction holes, and on/off switching of the application of back tension can be controlled. The driving of the vacuum pump 92 is controlled by a control apparatus (not illustrated) of the inkjet recording apparatus 10.

The back tension application apparatus 80 is composed as described above. The action of this back tension application apparatus 80 is as described above.

When the paper P is conveyed by the conveyance drum 20 of the preceding stage, the paper is conveyed while rubbing over the suction holding surface 94 of the suction unit 90. A plurality of suction holes are formed in this suction holding surface 94, and the paper P is conveyed while being suctioned with negative pressure from these suction holes. As a result of this, a back tension is applied to the paper P. The trailing end portion of the paper P is conveyed over the suction holding surface 94 after the leading end portion of the paper P has been transferred to the conveyance drum 12, and therefore the paper P is wrapped about the circumferential surface of the conveyance drum 12 while a back tension is applied to the paper.

In this way, a back tension can be applied by suctioning the rear surface of the paper P also.

### <Pressing Roller>

In the series of embodiments described above, a composition is adopted in which the paper P is pressed against the circumferential surface (suctioning surface) of the conveyance drum 12 by a pressing roller 14 or against the circumferential surface (suctioning surface) of a conveyance belt 40, but it is also possible to adopt a composition in which a pressing roller 14 is not provided.

By providing a pressing roller 14, it is possible to cause the paper P to make tight contact with the circumferential surface (suctioning surface) of the conveyance drum 12 or the circumferential surface (suctioning surface) of the conveyance belt 40, more efficiently.

The mode of the pressing roller 14 is not limited to a roller with a straight shape (a pressing roller having a uniform external diameter), and it is also possible to use a roller having a so-called “crown” shape (a pressing roller which is formed in such a manner that the external diameter becomes smaller from the center towards either end) (see FIG. 34). By using a crown-shaped pressing roller 14, it is possible to apply a tension in the width direction of the paper P also, and therefore the occurrence of wrinkling and floating can be prevented more effectively.

Wrinkling and floating of the paper P occurs due to localized concentration of cockling because the cockling that occurs in the paper P when it is sought to cause the paper P to make tight contact with the suctioning surface has no place to escape. However, the suctioning surface according to the present embodiment is able to absorb cockling due to having a concavoconvex arrangement, and therefore even if it is sought to cause the paper P to make tight contact with the suctioning surface forcibly by means of a pressing roller 14, the paper P can be caused to make tight contact with the suctioning surface without the occurrence of wrinkling or floating.

### <Other Features>

There are no particular restrictions on the type of medium and the type of ink used in the inkjet recording apparatus according to the present invention, but deformation of the medium is especially marked when using aqueous ink on paper of which main component is cellulose (so-called generic printing paper), such as coated paper. Therefore, the present invention is particularly effective when used in an inkjet recording apparatus which carries out printing using this combination of paper and ink.

### Practical Examples

In the inkjet recording apparatus shown in FIG. 1, an experiment to investigate the circumstances in which floating of paper occurs, and the circumstances in which image non-uniformities occur was carried out by conveying papers of different thicknesses (paper having different basis weights) by altering the conditions of the concavoconvex arrangement formed in the circumferential surface (suctioning surface) of the conveyance drum 12.

Hemispherical projecting sections are arranged at uniform intervals apart in the front/rear and left/right in the conveyance direction of the paper to form a concavoconvex arrangement (see FIG. 22 to FIG. 24). Furthermore, experimentation was also carried out by altering the height and interval of the projecting sections.

### [Evaluation of Paper Floating]

The circumstances in which floating of the paper occurs were investigated by conveying papers of different thicknesses while altering the interval (pitch) between the projecting sections which form the concavoconvex arrangement on the suctioning surface.

The experiment was performed by conveying paper on which solid printing (ejecting droplets of 5 pl at 1200 dpi×1200 dpi) had been carried out using aqueous ink onto half of the surface to simulate rear surface printing circumstances where floating is liable to occur, (the paper being conveyed with the printed surface on the rear side), and then investigating the circumstances in which floating of the paper occurred due to twisting of the paper at the boundary between the image portion (the portion which had received solid printing) and the non-image portion.

In the experiment, the projecting sections had a hemispherical shape with a height of 0.1 mm, and the interval therebetween was varied in 1 mm increments. The range of variation was 1 mm to 10 mm.

Furthermore, the papers used were papers having a basis weight (weight per 1 m² of the paper) of 81.9 g/m², 104.7 g/m² and 127.9 g/m². The thickness of the paper was greater, the larger the basis weight.

The paper used was “OK Top Coat Matt N” manufactured by Oji Paper Group, which is coated printing paper. Ink droplets were ejected onto the paper using aqueous ink, and the elongation of the paper after drying was found to become greater in the following order: 81.9 g/m²>104.7 g/m²>127.9 g/m². In the case of paper having a basis weight of 157 g/m², even if there is no concavoconvex arrangement on the suctioning surface, the amount of elongation is not sufficient to produce floating of the paper.

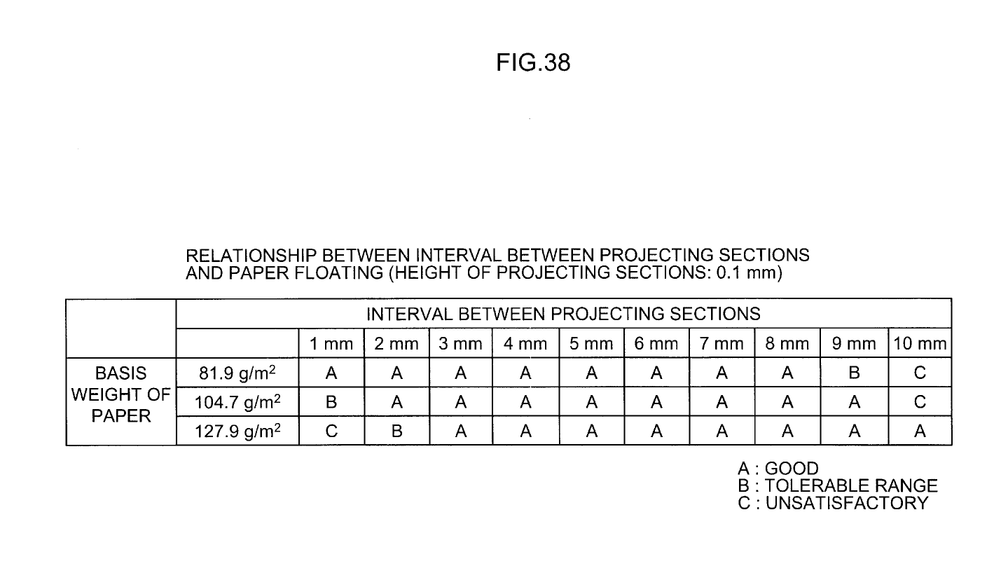

FIG. 38 is a table showing experimental results of investigation into the circumstances under which floating of the paper occurred when the interval between the projecting sections was varied.

In this table, “A” indicates a good result in relation to the evaluation of floating of the paper. Furthermore, “B” indicates a result within a tolerable range in relation to the evaluation of floating of the paper. Furthermore, “C” indicates an unsatisfactory result in relation to the evaluation of floating of the paper.

As can be confirmed from the table of experiment results, if the interval between the projecting sections becomes smaller as the basis weight of the paper becomes larger (as the thickness of the paper becomes greater, for instance), then it tends to become impossible to absorb floating satisfactorily.

Moreover, if the interval between the projecting sections becomes larger as the basis weight of the paper becomes smaller (as the thickness of the paper becomes smaller, for instance), then it tends to become impossible to absorb floating satisfactorily.

The fact that it becomes impossible to absorb floating satisfactorily if the intervals between the projecting sections become smaller as the basis weight of the paper becomes larger (as the thickness of the paper becomes greater) is thought to be because paper having a larger basis weight (thick paper) has high stiffness, and therefore if the intervals between the projecting sections are made too small, the paper cannot follow the projecting sections and hence floating cannot be absorbed.

Furthermore, the fact that it becomes impossible to absorb floating satisfactorily if the interval between projecting sections becomes larger as the basis weight of the paper becomes smaller (as the thickness of the paper becomes smaller) is thought to be because paper having a small basis weight (thin paper) produces a large amount of deformation, and therefore if the interval between the projecting sections is too large, the distance of the surface followed by the paper is insufficient to absorb the distortion of the paper.

Consequently, if using general printing paper which is employed in normal printing, then from the viewpoint of effectively suppressing floating, the interval between the projecting sections is desirably set to a range of 2 mm to 9 mm, and more desirably, to a range of 3 mm to 8 mm.

### [Evaluation of Image Non-Uniformities]

Papers of different thicknesses were conveyed while varying the height of the projecting sections which form the concavoconvex arrangement in the suctioning surface, a prescribed test pattern image was printed on the paper, and the circumstances in which image non-uniformities occurred were investigated.

The experiment was performed by conveying paper on which solid printing (ejecting droplets of 5 pl at 1200 dpi×1200 dpi) had been carried out using aqueous ink onto half of the surface to simulate rear surface printing circumstances where image non-uniformities are liable to occur, (the paper being conveyed with the printed surface on the rear side), and then investigating the circumstances in which image non-uniformities occurred due to twisting of the paper at the boundary between the image portion (the portion which had received solid printing) and the non-image portion.

The experiment was carried out with projecting sections having a hemispherical shape set at an arrangement interval of 6 mm apart, the height of the projecting sections being varied in increments of 0.05 mm. The range of variation was 0.05 mm to 0.50 mm.

Furthermore, the papers used were papers having a basis weight (weight per 1 m² of the paper) of 81.9 g/m², 104.7 g/m² and 127.9 g/m².

The paper used was “OK Top Coat Matt N” manufactured by Oji Paper Group, which is coated printing paper.

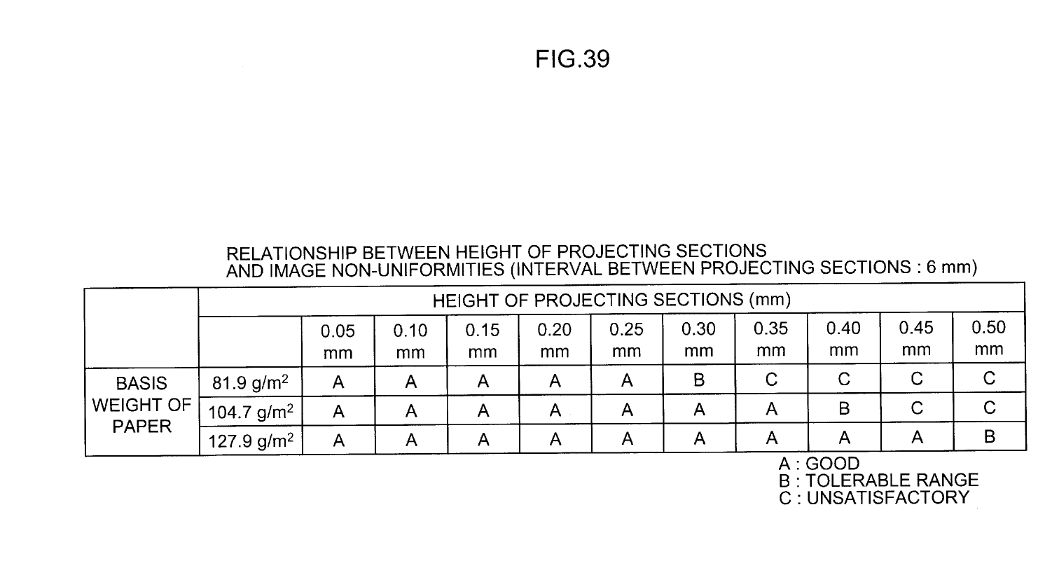

FIG. 39 is a table showing experimental results of investigation into the circumstances under which image non-uniformities occurred when the height of the projecting sections was varied.

In this table, “A” indicates a good result in relation to the evaluation of image non-uniformities. Furthermore, “B” indicates a result within a tolerable range in relation to the evaluation of image non-uniformities. Furthermore, “C” indicates an unsatisfactory result in relation to the evaluation of image non-uniformities.

As this table of experimental results shows, image non-uniformities tend to become more liable to occur, the greater the height of the projecting sections. Furthermore, image non-uniformities tend to become more liable to occur, the smaller the basis weight of the paper (the smaller the thickness of the paper).

The fact that image non-uniformities become more liable to occur, the greater the height of the projecting sections, is thought to be because deviation in the depositing positions becomes more liable to occur, the greater the height of the projecting sections.

Moreover, the fact that image non-uniformities become more liable to occur, the smaller the basis weight of the paper (the smaller the thickness of the paper), is thought to be because paper having a small basis weight (paper having a small thickness) has low stiffness and is liable to follow the shape of the projecting sections, and therefore image non-uniformities become more liable to occur in accordance with the height of the projecting sections.

Consequently, if using general printing paper which is employed in normal printing, then from the viewpoint of suppressing the occurrence of image non-uniformities, the height h of the projecting sections is desirably set to a range of 0<h≦0.3 mm, and more desirably, to a range of 0<h≦0.25 mm.

To summarize the foregoing, when using general printing paper which is employed in normal printing, from the viewpoint of suppressing floating of the paper and image non-uniformities, the interval between the projecting sections is set desirably to a range of 2 mm to 9 mm and more desirably to a range of 3 mm to 8 mm, and the height h of the projecting sections is set desirably to a range of 0<h≦0.3 mm and more desirably, to a range of 0<h≦0.25 mm.

It should be understood, however, that there is no intention to limit the invention to the specific forms disclosed, but on the contrary, the invention is to cover all modifications, alternate constructions and equivalents falling within the spirit and scope of the invention as expressed in the appended claims.

1. An inkjet recording apparatus, comprising:
a conveyance device which has a moving suctioning surface and which conveys a cut sheet medium (P) by suctioning the medium on the suctioning surface, a concavoconvex pattern being formed in the suctioning surface by arranging recess sections regularly in the suctioning surface, and suction holes each having an opening smaller than a size of openings of the recess sections being formed inside the recess sections; and
a recording head which forms an image by ejecting ink by an inkjet method onto a surface of the medium which is conveyed by the conveyance device.

2. The inkjet recording apparatus as defined in claim 1, wherein the concavoconvex pattern is formed in the suctioning surface by arranging the recess sections in front/rear and left/right in a conveyance direction of the medium.

3. The inkjet recording apparatus as defined in claim 1, wherein suction holes are also formed in projecting sections of the suctioning surface.

4. The inkjet recording apparatus as defined in claim 1, wherein a grid-shaped concavoconvex pattern is formed in the suctioning surface by arranging rectangular recess sections uniformly in front/rear and left/right in a conveyance direction of the medium.

5. The inkjet recording apparatus as defined in claim 1, wherein a checkerboard-shaped concavoconvex pattern is formed by arranging rectangular recess sections uniformly in front/rear and left/right in a conveyance direction of the medium.

6. The inkjet recording apparatus as defined in claim 4, wherein edges of the recess sections are inclined with respect to the conveyance direction of the medium.

7. The inkjet recording apparatus as defined in claim 6, wherein the edges of the recess sections are inclined at 45 degrees with respect to the conveyance direction of the medium.

8. The inkjet recording apparatus as defined in claim 4, wherein a length of each of the edges of the recess sections exceeds 3 [mm] and is no greater than 10 [mm].

9. The inkjet recording apparatus as defined in claim 8, wherein a width of each of the projecting sections is no greater than 10 [mm].

10. The inkjet recording apparatus as defined in claims 1, wherein a honeycomb-shaped concavoconvex pattern is formed in the suctioning surface.

11. An inkjet recording apparatus, comprising:
a conveyance device which has a moving suctioning surface and which conveys a cut sheet medium by suctioning the medium on the suctioning surface, a concavoconvex pattern being formed in the suctioning surface by arranging projecting sections regularly in the suctioning surface, and suction holes being arranged regularly in a region of the suctioning surface other than the projecting sections; and
a recording head which forms an image by ejecting ink by an inkjet method onto a surface of the medium which is conveyed by the conveyance device.

12. The inkjet recording apparatus as defined in claim 11, wherein first straight lines which are parallel to a conveyance direction of the medium are arranged on the suctioning surface, second straight lines which are perpendicular to the conveyance direction of the medium are arranged on the suctioning surface, and the projecting sections are arranged at intersection points of the first straight lines and the second straight lines on the suctioning surface.

13. The inkjet recording apparatus as defined in claim 12, wherein the suction holes are arranged in a center of each of regions demarcated by the first straight lines and the second straight lines.

14. The inkjet recording apparatus as defined in claim 11, wherein first straight lines which are inclined at an angle of λ, with respect to a conveyance direction of the medium are arranged on the suctioning surface, second straight lines which are inclined at an angle of −λ, with respect to the conveyance direction of the medium are arranged on the suctioning surface, and the projecting sections are arranged at intersection points of the first straight lines and the second straight lines on the suctioning surface.

15. The inkjet recording apparatus as defined in claim 14, wherein third straight lines which are perpendicular to the conveyance direction of the media and which pass through the intersection points are arranged on the suctioning surface, and the suction holes are arranged at a center of each of regions demarcated by the first straight lines, the second straight lines and the third straight lines.

16. The inkjet recording apparatus as defined in claim 11, wherein suction holes are also formed in the projecting sections of the suctioning surface.

17. The inkjet recording apparatus as defined in claim 11, wherein the projecting sections are formed in a hemispherical shape.

18. The inkjet recording apparatus as defined in claim 12, wherein the straight lines are arranged at a pitch of 2 to 9 [mm] and the projecting sections are formed to a height of no more than 0.3 [mm].

19. The inkjet recording apparatus as defined in claim 1, wherein a diameter of each of the suction holes is no more than 1 [mm].

20. The inkjet recording apparatus as defined in claim 1, further comprising a nip device which nips the medium against the suctioning surface and causes a rear surface of the medium to make tight contact with the suctioning surface.

21. The inkjet recording apparatus as defined in claim 1, further comprising a back tension application device which applies back tension to the medium transferred to the conveyance device, by suctioning a front surface or a rear surface of the medium transferred to the conveyance device.
